(19) United States
(12) Patent Application Publication
(10) Pub. No.: US 2018/0053337 A1
(43) Pub. Date: Feb. 22, 2018

(54) INFORMATION PROCESSING METHOD AND SYSTEM FOR EXECUTING THE SAME

(71) Applicant: COLOPL, Inc., Tokyo (JP)

(72) Inventors: Kento NAKASHIMA, Tokyo (JP); Yuichiro ARAI, Tokyo (JP)

(21) Appl. No.: 15/680,213

(22) Filed: Aug. 18, 2017

(30) Foreign Application Priority Data
Aug. 19, 2016 (JP) 2016-161038

(51) Int. Cl. G06T 15/20; G06F 3/01; G06T 19/20; H04N 5/232

(52) U.S. Cl. CPC G06T 15/205; G06F 3/012; H04N 5/23238; G06T 19/20; G06F 3/017

(57) ABSTRACT

A method of providing a virtual space in which a user is immersed to a head mounted display. The method includes moving an operation object based on a detected movement of a part of a body of the user. The method further includes projecting the virtual space in a different mode in response to a determination that the operation object and a projection portion on which omnidirectional video is projected are in contact with each other.

### RELATED APPLICATIONS

The present application claims priority to Japanese Application Number 2016-161038, filed Aug. 19, 2016, the disclosure of which is hereby incorporated by reference herein in its entirety.

### BACKGROUND

This disclosure relates to an information processing method and a system for executing the information processing method.

Japanese Patent Application Laid-open No. 2003-319351, describes a system for distributing omnidirectional video taken by an omnidirectional camera. “Toybox Demo for Oculus Touch”, [online], Oct. 13, 2015, Oculus, [retrieved on Aug. 6, 2016], Internet <https://www.youtube.com/watch?v=iFEMiyGMa58>, describes a technology of changing a state of a hand object in a virtual reality (VR) space based on a state (for example, position and inclination) of a hand of a user in a real space, and operating the hand object to exert a predetermined action on a predetermined object in the virtual space.

In recent years, there has been proposed a technology of distributing omnidirectional video via a network so that the user can view the video with use of a head mounted display (HMD). In this case, employing a technology such as that in “Toybox Demo for Oculus Touch”, [online], Oct. 13, 2015, Oculus, [retrieved on Aug. 6, 2016], Internet <https://www.youtube.com/watch?v=iFEMiyGMa58>, is possible to provide such a virtual experience that the user can interact with virtual content, for example, the omnidirectional video. However, defining of various objects in the virtual content in order to provide a virtual experience to the user leads to a risk of an increase in a data amount of the virtual content.

### SUMMARY

At least one embodiment of this disclosure has an object to provide a virtual experience to a user while preventing an increase in a data amount of virtual content.

According to at least one embodiment of this disclosure, there is provided an information processing method for use in a system including a head mounted display (HMD) and a position sensor configured to detect a position of the HMD and a position of apart of a body of a user other than a head of the user. The information processing method includes specifying virtual space data for defining a virtual space including a virtual camera, an operation object, omnidirectional video, and a projection portion on which the omnidirectional video is projected. The method further includes projecting the omnidirectional video on the projection portion in a first mode. The method further includes moving the virtual camera based on a movement of the HMD. The method further includes defining a visual field of the virtual camera based on a movement of the virtual camera, and generating visual-field image data based on the visual field and the virtual space data. The method further includes displaying a visual-field image on the HMD based on the visual-field image data. The method further includes moving the operation object based on a movement of the part of the body. The method further includes projecting the omnidirectional video on the projection portion in a second mode different from the first mode when the operation object and the projection portion are in contact with each other.

According to at least one embodiment of this disclosure, providing a virtual experience to a user while preventing an increase in a data amount of virtual content is possible.

### BRIEF DESCRIPTION OF THE DRAWINGS

FIG. 1 is a schematic view of a head mounted display (HMD) system according to at least one embodiment.

FIG. 2 is a diagram of a head of a user wearing an HMD according to at least one embodiment.

FIG. 3 is a diagram of a hardware configuration of a control device according to at least one embodiment.

FIG. 4 is a view of a configuration of an external controller according to at least one embodiment.

FIG. 5 is a flow chart of a method of displaying a visual-field image on the HMD according to at least one embodiment.

FIG. 6 is an xyz spatial diagram of a virtual space according to at least one embodiment.

FIG. 7A is an illustration of a yx plane diagram of the virtual space illustrated in FIG. 6 according to at least one embodiment.

FIG. 7B is an illustration of a zx plane diagram of the virtual space illustrated in FIG. 6 according to at least one embodiment.

FIG. 8A is a diagram of a visual-field image displayed on the HMD according to at least one embodiment.

FIG. 8B is a diagram of a relationship between an operation object and a projection portion according to at least one embodiment.

FIG. 9A is a diagram of a user wearing the HMD and the external controller according to at least one embodiment.

FIG. 9B, is a diagram of a virtual space including a virtual camera and operation objects (hand object and target object) according to at least one embodiment.

FIG. 10 is a flow chart of an information processing method according to at least one embodiment of this disclosure.

FIG. 11A is an illustration of a visual-field image according to at least one embodiment.

FIG. 11B is an illustration of a relationship between an operation object and a projection portion according to at least one embodiment.

FIG. 12A is an illustration of a visual-field image according to at least one embodiment.

FIG. 12B is an illustration of a relationship between the operation object and the projection portion according to at least one embodiment.

FIG. 13 is a table of video data for defining an omnidirectional moving image according to at least one embodiment.

FIG. 14 is a flow chart of an information processing method according to at least one embodiment of this disclosure.

FIG. 15A is an illustration of a visual-field image according to at least one embodiment.

FIG. 15B is an illustration of a relationship between the operation object and the projection portion according to at least one embodiment.

FIG. 16A is an illustration of a visual-field image according to at least one embodiment.

FIG. 16B is an illustration of a relationship between the operation object and the projection portion according to at least one embodiment.

FIG. 17 is an illustration of an information processing method summarized based on a playing time of the omnidirectional video according to at least one embodiment of this disclosure.

FIG. 18 is a flow chart of an information processing method according to at least one embodiment of this disclosure.

FIG. 19A is an illustration of a visual-field image according to at least one embodiment.

FIG. 19B is an illustration of a relationship between the operation object and the projection portion according to at least one embodiment.

FIG. 20A is an illustration of a visual-field image according to at least one embodiment.

FIG. 20B is an illustration of a relationship between the operation object and the projection portion according to at least one embodiment.

FIG. 21 is an illustration of an information processing method summarized based on the playing time of the omnidirectional video according to at least one embodiment of this disclosure.

### DETAILED DESCRIPTION

The summary of at least one embodiment of this disclosure is described.

(Item. 1) An information processing method for use in a system including a head mounted display (HMD) and a position sensor configured to detect a position of the HMD and a position of a part of a body of a user other than a head of the user. The information processing method includes specifying virtual space data for defining a virtual space including a virtual camera, an operation object, omnidirectional video, and a projection portion on which the omnidirectional video is projected. The method further includes projecting the omnidirectional video on the projection portion in a first mode. The method further includes moving the virtual camera based on a movement of the head mounted display. The method further includes defining a visual field of the virtual camera based on a movement of the virtual camera, and generating visual-field image data based on the visual field and the virtual space data. The method further includes displaying a visual-field image on the head mounted display based on the visual-field image data. The method further includes moving the operation object based on a movement of the part of the body. The method further includes projecting the omnidirectional video on the projection portion in a second mode different from the first mode when the operation object and the projection portion are in contact with each other.

According to the information processing method of Item 1, the display mode of the omnidirectional video is changed based on an interaction between the operation object and the projection portion on which the omnidirectional video is projected. With this, while suppressing increase in data amount of the omnidirectional video content data, a virtual experience may be provided to the user based on an interaction with the virtual content.

(Item 2) An information processing method according to Item 1, in which the projection portion is sectioned into a plurality of parts including a first part and a second part different from the first part. At least a part of a display target is displayed on the first part. Projecting the omnidirectional video includes changing a display mode of the display target to change the omnidirectional video from the first mode to the second mode when the operation object is in contact with the first part or when the operation object is in contact with the second part.

With this, the display mode of the display target that the user intends to touch can be selectively changed, and hence the virtual experience maybe provided based on an intuitive interaction with the virtual content.

(Item 3)An information processing method according to Item 1 or 2, in which the operation object includes a virtual body that is movable in synchronization with the movement of the part of the body.

With this, the virtual experience may be provided based on an intuitive interaction with the virtual content.

(Item 4) An information processing method according to Item 1 or 2, in which the operation object includes a target object capable of exhibiting a behavior operated by a virtual body that is movable in synchronization with the movement of the part of the body.

With this, the virtual experience may be provided based on an intuitive interaction with the virtual content.

(Item 5) An information processing method according to Item 3 or 4, in which the projection portion is sectioned into a plurality of parts including a first part and a second part different from the first part. At least a part of a display target is displayed on the first part. The display target is configured to change a display mode based on the first mode along with elapse of a playing time of the omnidirectional video. Projecting the omnidirectional video includes changing the display mode of the display target to change the omnidirectional video from the first mode to the second mode when the operation object is in contact with the first part or when the operation object is in contact with the second part. Projecting the omnidirectional video further includes specifying a viewing target associated with the display target based on a time at which the operation object is in contact with the first part, to thereby output information for specifying the viewing target.

With this, the viewing target with which the user desires to interact can be specified based on the part in which the operation object and the projection portion are in contact with each other. Therefore, when advertisements or other items are displayed in the omnidirectional moving image, the advertising effectiveness can be measured.

(Item 6) An information processing method according to Item 3 or 4, in which the projection portion is sectioned into a plurality of parts including a first part and a second part different from the first part. At least a part of a display target is displayed on the first part. The display target is configured to change a display mode along with elapse of a playing time of the omnidirectional video, based on one of the first mode and the second mode for displaying the same content in different display modes. Projecting the omnidirectional video includes, when the operation object is in contact with the first part or when the operation object is in contact with the second part, changing the display mode of the display target to change the omnidirectional video from the first mode to the second mode, and continuously changing the display mode of the display target based on the second mode along with the elapse of the playing time.

With this, providing, to the user, a virtual experience that is based on the interaction with the virtual content while providing the omnidirectional video that progresses based on predetermined content is possible.

(Item 7) An information processing method according to Item 3 or 4, in which the projection portion is sectioned into a plurality of parts including a first part and a second part different from the first part. At least a part of a display target is displayed on the first part. The display target is configured to change a display mode along with elapse of a playing time of the omnidirectional video, based on one of the first mode and the second mode for displaying different contents. Projecting the omnidirectional video includes changing the display mode of the display target to change the omnidirectional video from the first mode to the second mode when the operation object is in contact with the first part or when the operation object is in contact with the second part. Projecting the omnidirectional video further includes stopping the changing of the display mode of the display target based on the first mode along with the elapse of the playing time. Projecting the omnidirectional video further includes changing the display mode of the display target based on the second mode for a predetermined period along with the elapse of the playing time. Projecting the omnidirectional video further includes restarting the changing of the display mode of the display target based on the first mode along with the elapse of the playing time.

With this, providing, to the user, a virtual experience that is based on the interaction with the virtual content while providing the omnidirectional video that progresses based on predetermined content is possible.

(Item 8) A system for executing the information processing method of any one of Items 1 to 7.

At least one embodiment of this disclosure is described below with reference to the drawings. Once a component is described in this description of at least one embodiment, a description of a component having the same reference number as that of the already described component is omitted for the sake of convenience.

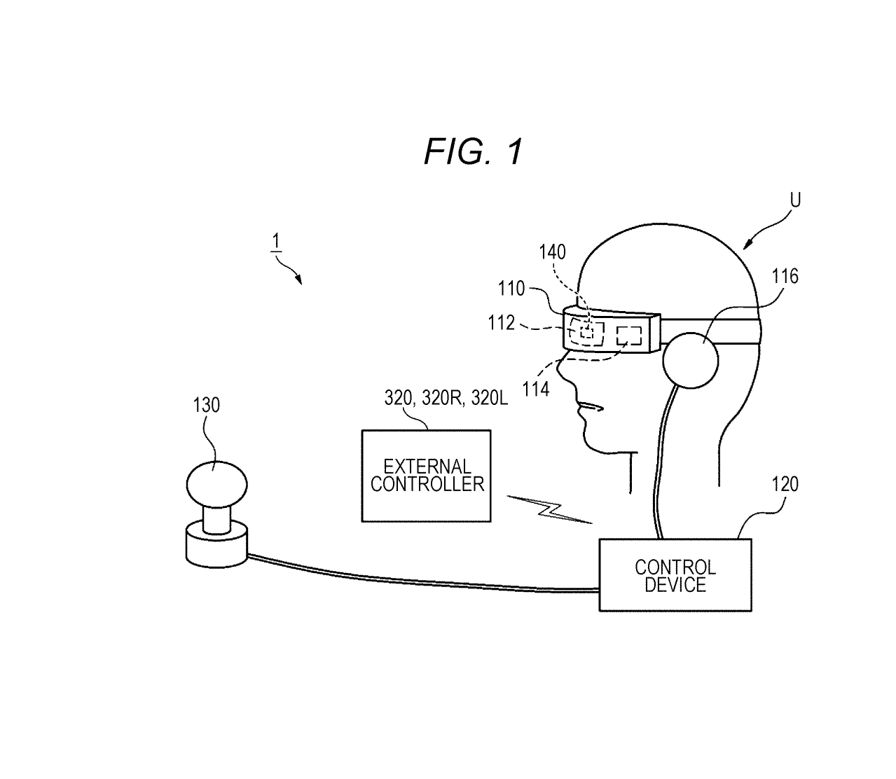

First, with reference to FIG. 1, a configuration of a head mounted display (HMD) system 1 is described. FIG. 1 is a schematic view of the HMD system 1 according to at least one embodiment. In FIG. 1, the HMD system 1 includes an HMD 110 worn on a head of a user U, a position sensor 130, a control device 120, and an external controller 320.

The HMD 110 includes a display unit 112, an HMD sensor 114, and an eye gaze sensor 140. The display unit 112 includes a non-transmissive display device (or partially transmissive display device) configured to cover a field of view (visual field) of the user U wearing the HMD 110. With this, the user U can see a visual-field image displayed on the display unit 112, and hence the user U can be immersed in a virtual space. The display unit 112 may include a left-eye display unit configured to provide an image to a left eye of the user U, and a right-eye display unit configured to provide an image to a right eye of the user U. Further, the HMD 110 may include a transmissive display device. In this case, the transmissive display device may be able to be temporarily configured as the non-transmissive display device by adjusting the transmittance the display unit 112. Further, the visual-field image may include a configuration for presenting a real space in apart of the image forming the virtual space. For example, an image taken by a camera mounted to the HMD 110 may be displayed so as to be superimposed on a part of the visual-field image, or a transmittance of a part of the transmissive display device may be set high to enable the user to visually recognize the real space through a part of the visual-field image.

The HMD sensor 114 is mounted near the display unit 112 of the HMD 110. The HMD sensor 114 includes at least one of a geomagnetic sensor, an acceleration sensor, or an inclination sensor (for example, an angular velocity sensor or a gyro sensor), and can detect various movements of the HMD 110 worn on the head of the user U.

The eye gaze sensor 140 has an eye tracking function of detecting a line-of-sight direction of the user U. For example, the eye gaze sensor 140 may include a right-eye gaze sensor and a left-eye gaze sensor. The right-eye gaze sensor may be configured to detect reflective light reflected from the right eye (in particular, the cornea or the iris) of the user U by irradiating the right eye with, for example, infrared light, to thereby acquire information relating to a rotational angle of a right eyeball. Meanwhile, the left-eye gaze sensor may be configured to detect reflective light reflected from the left eye (in particular, the cornea or the iris) of the user U by irradiating the left eye with, for example, infrared light, to thereby acquire information relating to a rotational angle of a left eyeball.

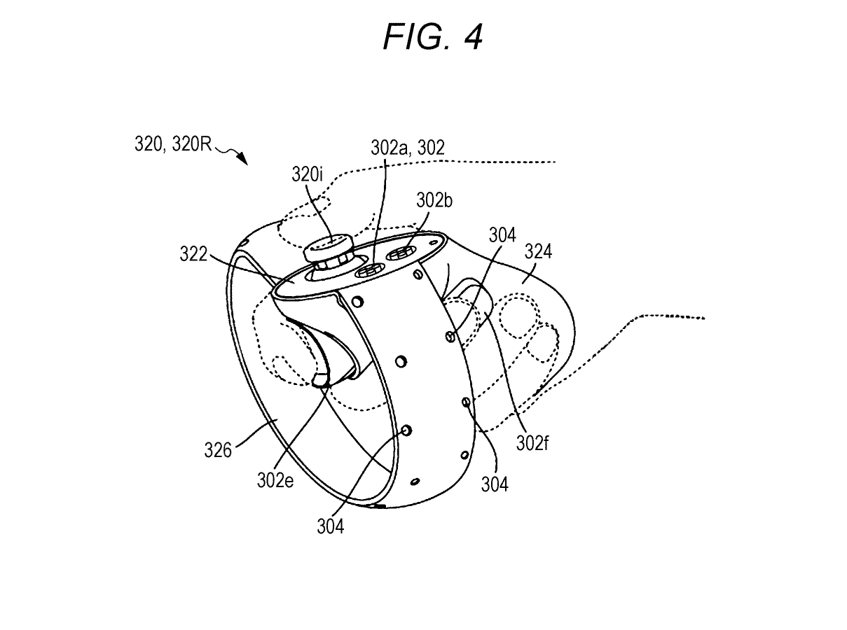

The position sensor 130 is constructed of, for example, a position tracking camera, and is configured to detect the positions of the HMD 110 and the external controller 320. The position sensor 130 is connected to the control device 120 so as to enable communication to/from the control device 120 in a wireless or wired manner. In at least one embodiment, the position sensor 130 is configured to detect information relating to positions, inclinations, or light emitting intensities of a plurality of detection points (not shown) provided in the HMD 110. Further, in at least one embodiment, the position sensor 130 is configured to detect information relating to positions, inclinations, and/or light emitting intensities of a plurality of detection points 304 (see FIG. 4) provided in the external controller 320. The detection points are, for example, light emitting portions configured to emit infrared light or visible light. Further, the position sensor 130 may include an infrared sensor or a plurality of optical cameras.

The control device 120 is capable of acquiring movement information such as the position and the direction of the HMD 110 based on the information acquired from the HMD sensor 114 or the position sensor 130, and accurately associating a position and a direction of a virtual point of view (virtual camera) in the virtual space with the position and the direction of the user U wearing the HMD 110 in the real space based on the acquired movement information. Further, the control device 120 is capable of acquiring movement information of the external controller 320 based on the information acquired from the position sensor 130, and accurately associating a position and a direction of a hand object (described later) to be displayed in the virtual space based on a relative relationship of the position and the direction between the external controller 320 and the HMD 110 in the real space using the acquired movement information. Similar to the HMD sensor 114, the movement information of the external controller 320 may be obtained from a geomagnetic sensor, an acceleration sensor, an inclination sensor, or other sensors mounted to the external controller 320.

The control device 120 is capable of determining each of the line of sight of the right eye and the line of sight of the left eye of the user U based on the information received from the eye gaze sensor 140. The control device 120 is able to specify a point of gaze as an intersection between the line of sight of the right eye and the line of sight of the left eye. Further, the control device 120 is capable of specifying a line-of-sight direction of the user U based on the specified point of gaze. In this case, the line-of-sight direction of the user U is a line-of-sight direction of both eyes of the user U, and corresponds to a direction of a straight line passing through the point of gaze and a midpoint of a line segment connecting between the right eye and the left eye of the user U.

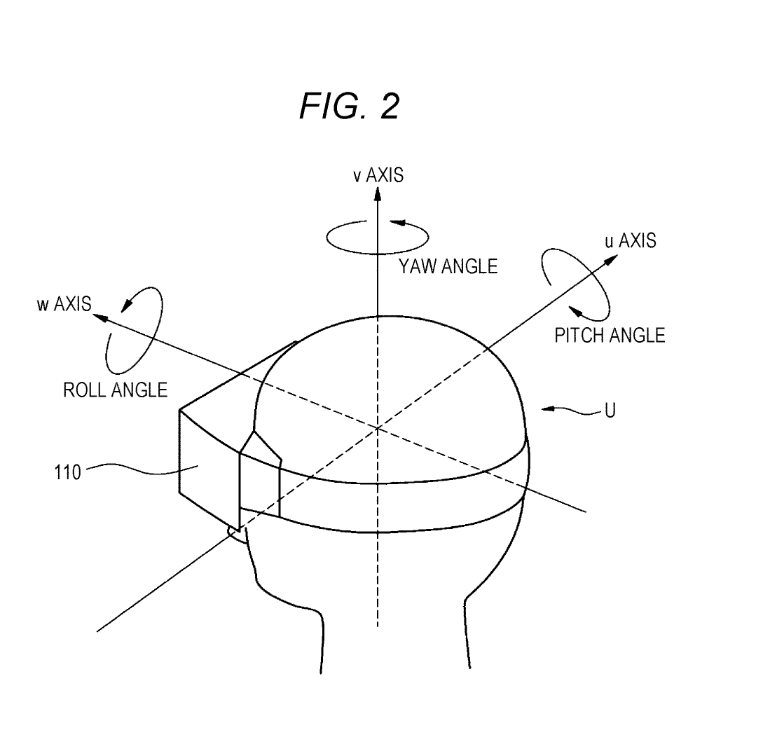

With reference to FIG. 2, a method of acquiring information relating to a position and a direction of the HMD 110 is described. FIG. 2 is a diagram of a head of the user U wearing the HMD 110 according to at least one embodiment. The information relating to the position and the direction of the HMD 110, which are synchronized with the movement of the head of the user U wearing the HMD 110, can be detected by the position sensor 130 and/or the HMD sensor 114 mounted on the HMD 110. In FIG. 2, three-dimensional coordinates (uvw coordinates) are defined about the head of the user U wearing the HMD 110. A perpendicular direction in which the user U stands upright is defined as a v axis, a direction being orthogonal to the v axis and passing through the center of the HMD 110 is defined as a w axis, and a direction orthogonal to the v axis and the w axis is defined as au direction. The position sensor 130 and/or the HMD sensor 114 are/is configured to detect angles about the respective uvw axes (that is, inclinations determined by a yaw angle representing the rotation about the v axis, a pitch angle representing the rotation about the u axis, and a roll angle representing the rotation about the w axis). The control device 120 is configured to determine angular information for defining a visual axis from the virtual viewpoint based on the detected change in angles about the respective uvw axes.

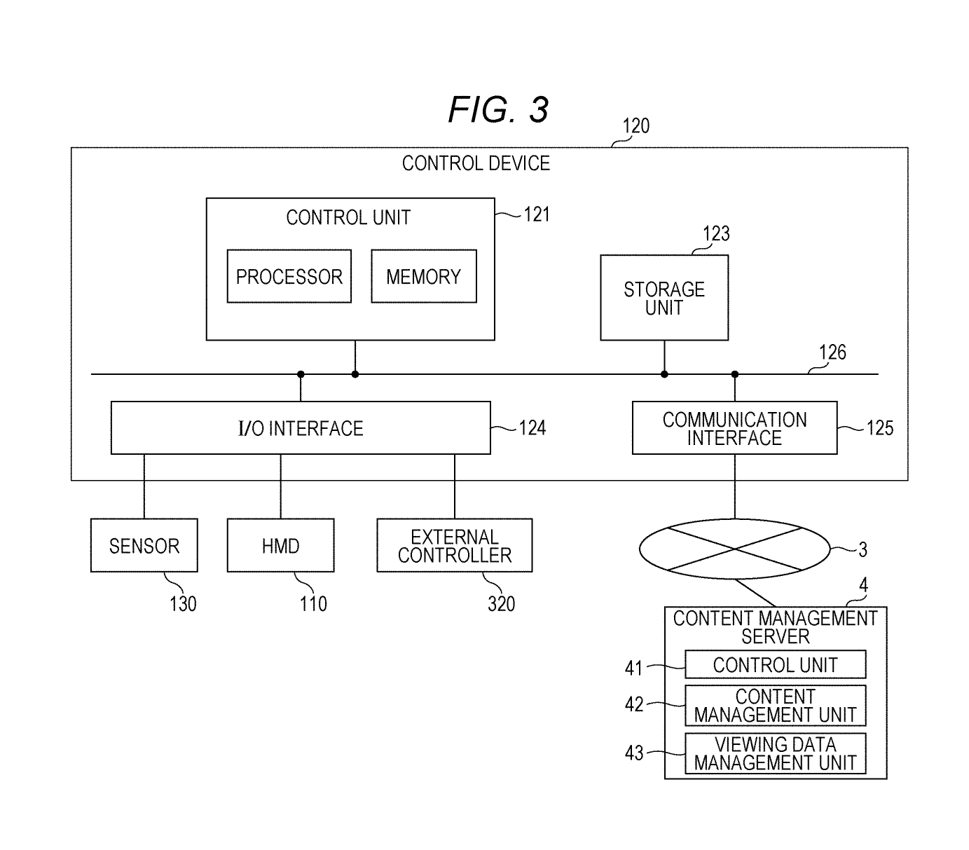

With reference to FIG. 3, a hardware configuration of the control device 120 is described. FIG. 3 is a diagram of a hardware configuration of the control device 120 according to at least one embodiment. The control device 120 includes a control unit 121, a storage unit 123, an input/output (I/O) interface 124, a communication interface 125, and a bus 126. The control unit 121, the storage unit 123, the I/O interface 124, and the communication interface 125 are connected to each other via the bus 126 so as to enable communication therebetween.

The control device 120 may be constructed as a personal computer, a tablet computer, or a wearable device separate from the HMD 110, or may be built into the HMD 110. Further, a part of the functions of the control device 120 maybe performed by a device mounted to the HMD 110, and other functions of the control device 120 may be performed by another device separate from the HMD 110.

The control unit 121 includes a memory and a processor.

The memory is constructed of, for example, a read only memory (ROM) having various programs and the like stored therein or a random access memory (RAM) having a plurality of work areas in which various programs to be executed by the processor are stored. The processor is constructed of, for example, a central processing unit (CPU), a micro processing unit (MPU) and/or a graphics processing unit (GPU), and is configured to develop, on the memory, instructions designated by various information installed into the memory to execute various types of processing in cooperation with the memory.

The control unit 121 may control various operations of the control device 120 by causing the processor to develop, on the memory, a instructions (to be described later) for executing the information processing method according to at least one embodiment to execute the instructions in cooperation with the memory. The control unit 121 executes a predetermined application program (including a game program and an interface program) stored in the memory or the storage unit 123 to provide instructions for displaying a virtual space (visual-field image) to the display unit 112 of the HMD 110. With this, the user U can be immersed in the virtual space displayed on the display unit 112.

The storage unit (storage) 123 is a storage device, for example, a hard disk drive (HDD), a solid state drive (SSD), or a USB flash memory, and is configured to store programs and various types of data. The storage unit 123 may store the instructions for causing the system to execute the information processing method according to at least one embodiment. Further, the storage unit 123 may store instructions for authentication of the user U and game programs including data relating to various images and objects. Further, a database including tables for managing various types of data may be constructed in the storage unit 123.

The I/O interface 124 is configured to connect each of the position sensor 130, the HMD 110, and the external controller 320 to the control device 120 so as to enable communication therebetween, and is constructed of, for example, a universal serial bus (USB) terminal, a digital visual interface (DVI) terminal, or a high-definition multimedia interface (TM) (HDMI) terminal. The control device 120 may be wirelessly connected to each of the position sensor 130, the HMD 110, and the external controller 320. In at least one embodiment, the control device 120 has a wired connection to at least one of position sensor 130, HMD 110 or external controller 320.

The communication interface 125 is configured to connect the control device 120 to a communication network 3, for example, a local area network (LAN), a wide area network (WAN), or the Internet. The communication interface 125 includes various wire connection terminals and various processing circuits for wireless connection for communication to/from an external device on a network via the communication network 3, and is configured to adapt to communication standards for communication via the communication network 3.

The control device 120 is connected to a content management server 4 via the communication network 3. The content management server 4 includes a control unit 41, a content management unit 42, and a viewing data management unit 43. The control unit 41 includes a memory and a processor. Each of the content management unit 42 and the viewing data management unit 43 includes a storage unit (storage). The content management unit 42 stores virtual space data for constructing virtual space content including various kinds of omnidirectional video to be described later. When the control unit 41 receives a viewing request for predetermined content from the control device 120, the control unit 41 reads out the virtual space data corresponding to the viewing request from the content management unit 42, and transmits the virtual space data to the control device 120 via the communication network 3. The control unit 41 receives data for specifying a user's viewing history, which is transmitted from the control device 120, and causes the viewing data management unit 43 to store the data.

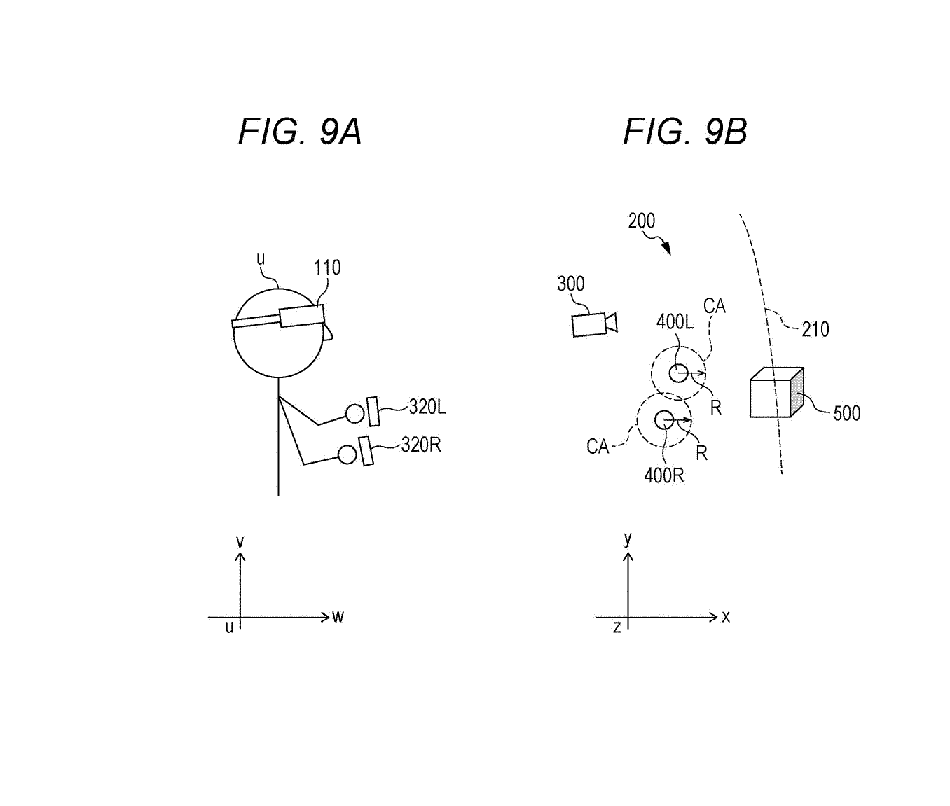

With reference to FIG. 4, an example of a specific configuration of the external controller 320 is described according to at least one embodiment. The external controller 320 is used to control a movement of a hand object to be displayed in the virtual space by detecting a movement of a part of a body of the user U (part other than the head, hand of the user U in this embodiment). The external controller 320 includes, for example, a right-hand external controller 320R (hereinafter simply referred to as “controller 320R”) to be operated by the right hand of the user U, and a left-hand external controller 320L (hereinafter simply referred to as “controller 320L”) to be operated by the left hand of the user U. The controller 320R is a device for representing the position of the right hand and the movement of the fingers of the right hand of the user U. Further, a right hand object 400R (see, for example, FIG. 9B) present in the virtual space moves based on the movement of the controller 320R. The controller 320L is a device for representing the position of the left hand and the movement of the fingers of the left hand of the user U. Further, a left hand object 400L (see, for example, FIG. 9B) present in the virtual space moves based on the movement of the controller 320L. In at least one embodiment, the controller 320R and the controller 320L substantially have the same configuration, and hence description is given only of the specific configuration of the controller 320R in the following with reference to FIG. 4. In the following description, for the sake of convenience, the controllers 320L and 320R are sometimes simply and collectively referred to as “external controller 320”. Further, the left hand object 400L and the right hand object 400R are sometimes simply and collectively referred to as “hand object 400”, “virtual hand”, “virtual body”, or the like.

In FIG. 4, the controller 320R includes an operation button 302, a plurality of detection points 304, a sensor (not shown), and a transceiver (not shown). Only one of the sensor or the detection points 304 needs to be provided. The operation button 302 includes a plurality of button groups configured to receive operation input from the user U in at least one embodiment. The operation button 302 includes a push button, a trigger button, or an analog stick. The push button is a button to be operated through a depression motion by the thumb in at least one embodiment. For example, two push buttons 302a and 302b are provided on a top surface 322. In at least one embodiment, when the thumb is placed on the top surface 322 or the thumb depresses the push buttons 302a and 302b, the thumb of the hand object 400 be changed from an extended state to a bent state. The trigger button is a button to be operated through such a motion that the index finger or the middle finger pulls a trigger. For example, a trigger button 302e is provided in a front surface part of a grip 324, and a trigger button 302f is provided in a side surface part of the grip 324. The trigger button 302e is intended to be operated by the index finger, and in at least one embodiment the index finger of the hand object 400 is changed from the extended state to the bent state through the depression. The trigger button 302f is intended to be operated by the middle finger, and in at least one embodiment the middle finger, the ring finger, or the little finger of the hand object 400 is changed from the extended state to the bent state through the depression. The analog stick is a stick button that may be operated by being tilted in an arbitrary direction of 360 degrees from a predetermined neutral position. For example, an analog stick 320i is provided on the top surface 322, and is intended to be operated with use of the thumb.

The controller 320R includes a frame 326 that extends from both side surfaces of the grip 324 in directions opposite to the top surface 322 to form a semicircular ring. The plurality of detection points 304 are embedded in the outer side surface of the frame 326. The plurality of detection points 304 are, for example, a plurality of infrared LEDs arranged in at least one row along a circumferential direction of the frame 326. The position sensor 130 detects information relating to positions, inclinations, and light emitting intensities of the plurality of detection points 304, and then the control device 120 acquires the movement information including the information relating to the position and the attitude (inclination and direction) of the controller 320R based on the information detected by the position sensor 130.

The sensor of the controller 320R may be, for example, any one of a magnetic sensor, an angular velocity sensor, or an acceleration sensor, or a combination of those sensors. The sensor outputs a signal (for example, a signal indicating information relating to magnetism, angular velocity, or acceleration) based on the direction and the movement of the controller 320R when the user U moves the controller 320R. The control device 120 acquires information relating to the position and the attitude of the controller 320R based on the signal output from the sensor.

The transceiver of the controller 320R is configured to perform transmission or reception of data between the controller 320R and the control device 120. For example, the transceiver may transmit an operation signal corresponding to the operation input of the user U to the control device 120. Further, the transceiver may receive an instruction signal for instructing the controller 320R to cause light emission of the detection points 304 from the control device 120. Further, the transceiver may transmit a signal representing the value detected by the sensor to the control device 120.

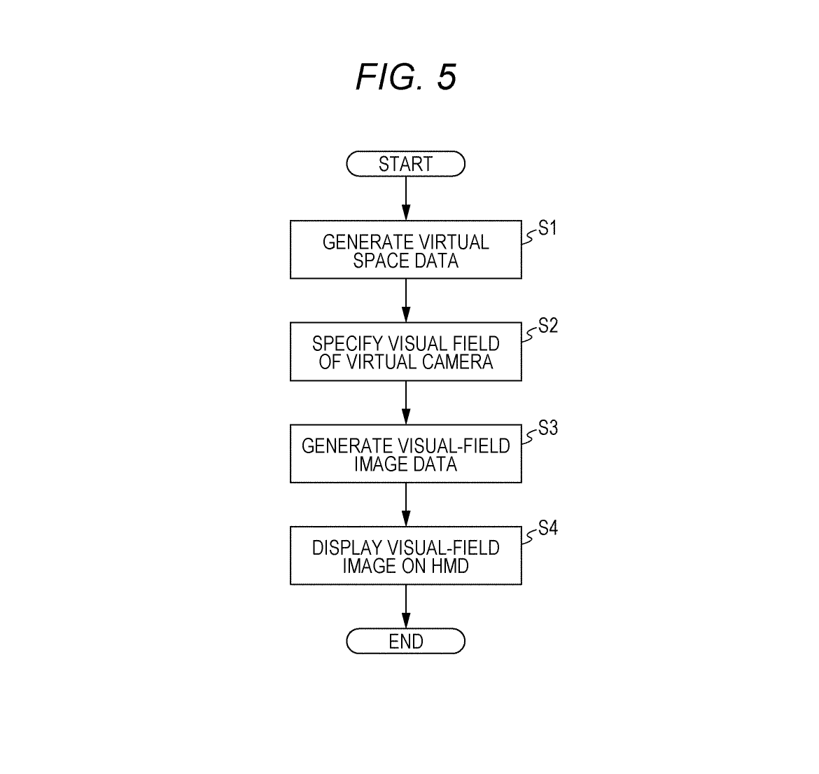

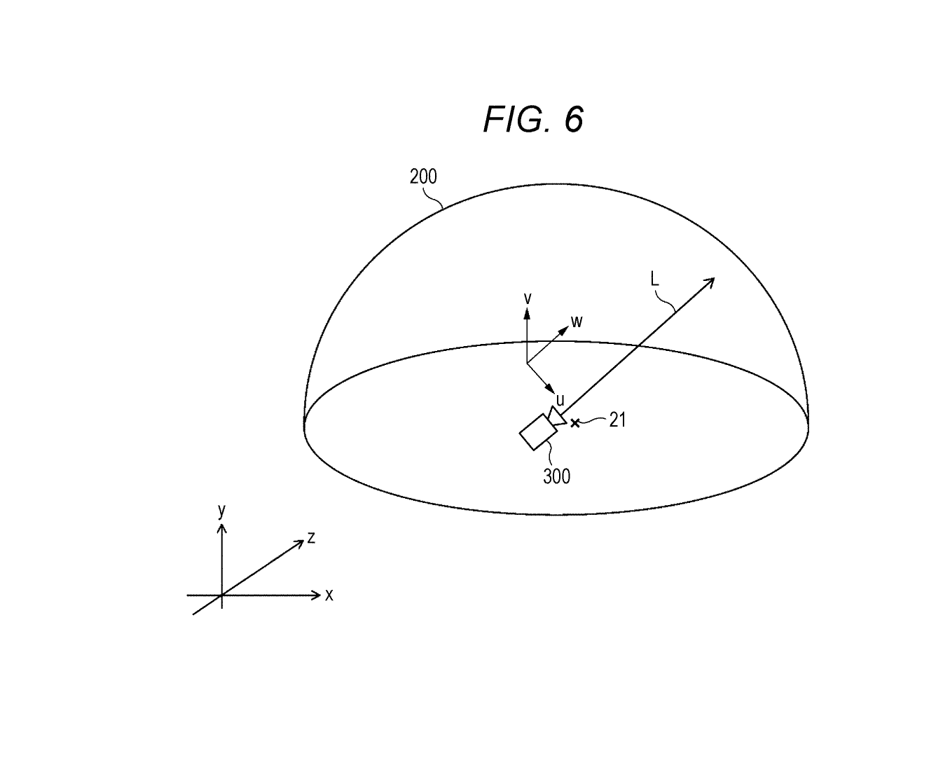

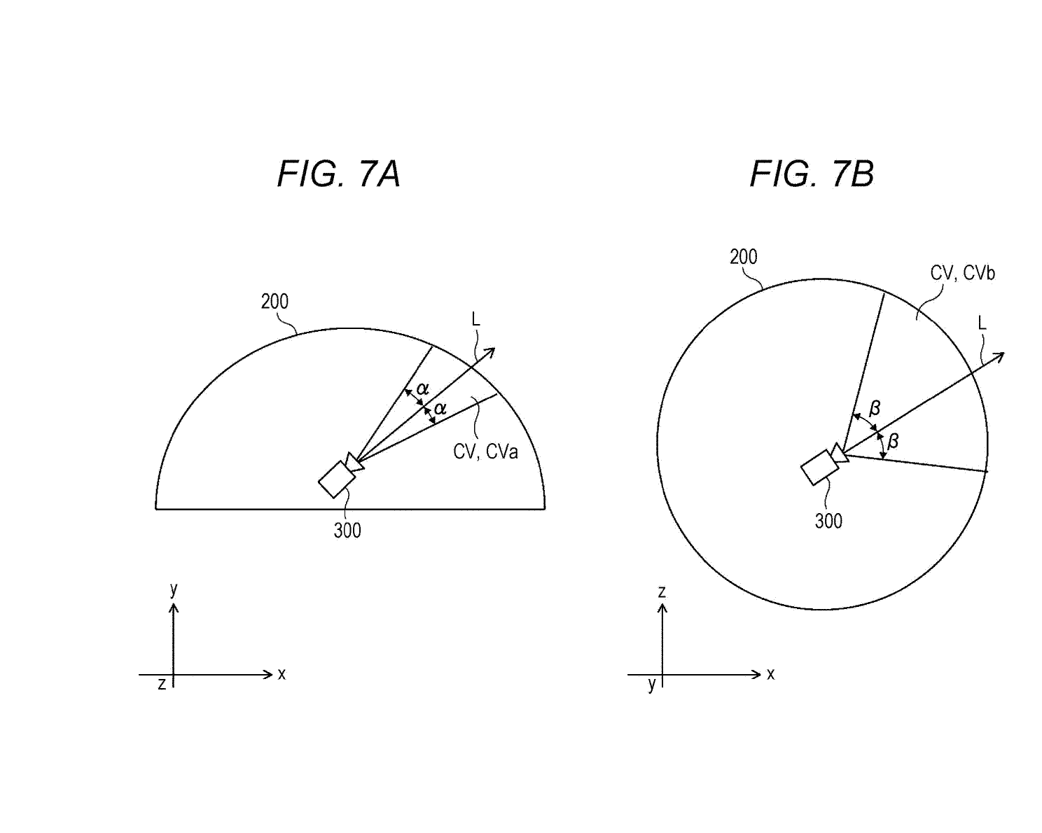

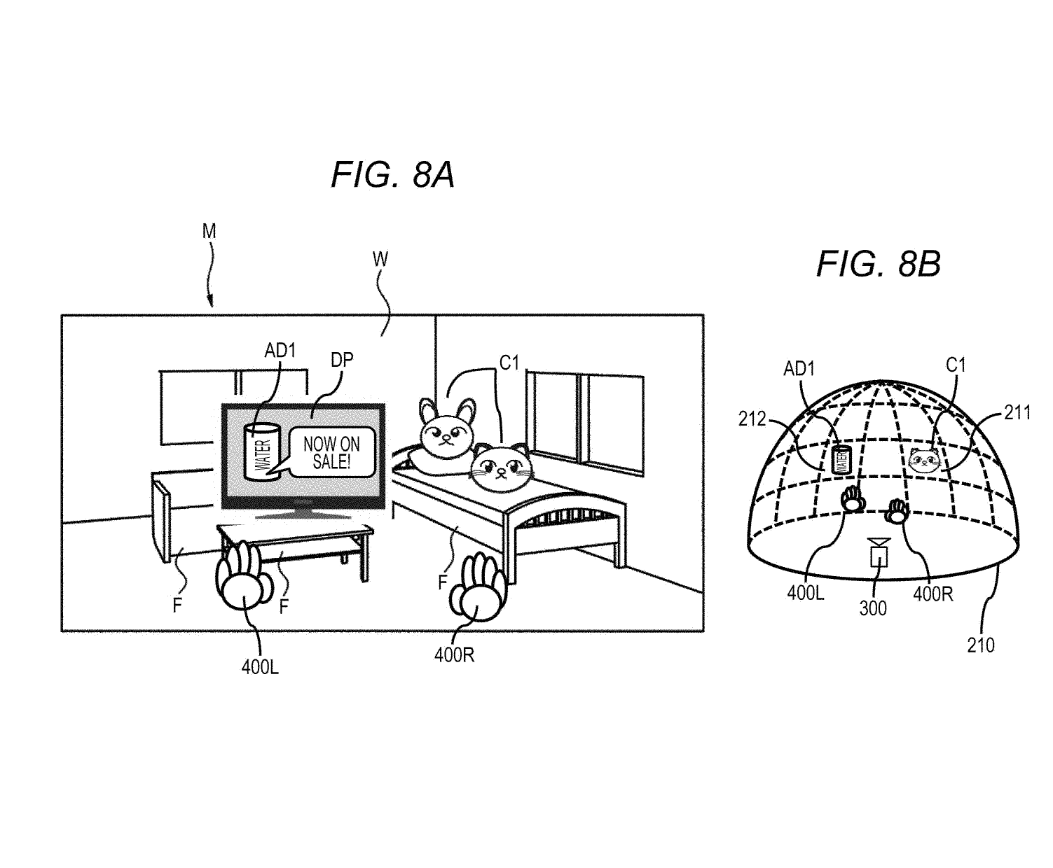

With reference to FIG. 5 to FIG. 8, processing for displaying the visual-field image on the HMD 110 is described. FIG. 5 is a flow chart of a method of displaying the visual-field image on the HMD 110 according to at least one embodiment. FIG. 6 is an xyz spatial diagram of a virtual space 200 according to at least one embodiment. FIG. 7A is a yx plane diagram of the virtual space 200 illustrated in FIG. 6 according to at least one embodiment. FIG. 7B is a zx plane diagram of the virtual space 200 illustrated in FIG. 6 according to at least one embodiment. FIG. 8A is a diagram of a visual-field image M displayed on the HMD 110 according to at least one embodiment. FIG. 8B is a diagram of a relationship between an operation object and a projection portion according to at least one embodiment

In FIG. 5, in Step S1, the control unit 121 (see FIG. 3) generates virtual space data. The virtual space data includes virtual content including omnidirectional video stored in the storage unit 123, a projection portion 210 for projecting the omnidirectional video, and various objects such as a virtual camera 300 and the hand object 400. In the following description, a state in which the omnidirectional video is projected on the projection portion 200 is sometimes referred to as “virtual space 200”. In FIG. 6, the virtual space 200 is defined as an entire celestial sphere having a center position 21 as the center (in FIG. 6, only the upper-half celestial sphere is illustrated). Further, in the virtual space 200, an xyz coordinate system having the center position 21 as the origin is set. The virtual camera 300 defines a visual axis L for specifying the visual-field image M (for example, see FIG. 8A) to be displayed on the HMD 110. The uvw coordinate system that defines the visual field of the virtual camera 300 is determined so as to synchronize with the uvw coordinate system that is defined about the head of the user U in the real space. Further, the control unit 121 may move the virtual camera 300 in the virtual space 200 based on the movement in the real space of the user U wearing the HMD 110. Further, the various objects in the virtual space 200 include, for example, the left hand object 400L, the right hand object 400R, and an operation object 500 (see, for example, FIG. 9B).

In Step S2, the control unit 121 specifies a visual field CV (see FIGS. 7A and 7B) of the virtual camera 300. Specifically, the control unit 121 acquires information relating to a position and an inclination of the HMD 110 based on data representing the state of the HMD 110, which is transmitted from the position sensor 130 and/or the HMD sensor 114. Next, the control unit 121 specifies the position and the direction of the virtual camera 300 in the virtual space 200 based on the information relating to the position and the inclination of the HMD 110. Next, the control unit 121 determines the visual axis L of the virtual camera 300 based on the position and the direction of the virtual camera 300, and specifies the visual field CV of the virtual camera 300 based on the determined visual axis L. In this case, the visual field CV of the virtual camera 300 corresponds to a part of the region of the virtual space 200 that can be visually recognized by the user U wearing the HMD 110. In other words, the visual field CV corresponds to a part of the region of the virtual space 200 to be displayed on the HMD 110. Further, the visual field CV has a first region CVa set as an angular range of a polar angle a about the visual axis L in the xy plane illustrated in FIG. 7A, and a second region CVb set as an angular range of an azimuth β about the visual axis L in the xz plane illustrated in FIG. 7B. The control unit 121 may specify the line-of-sight direction of the user U based on data representing the line-of-sight direction of the user U, which is transmitted from the eye gaze sensor 140, and may determine the direction of the virtual camera 300 based on the line-of-sight direction of the user U.

The control unit 121 can specify the visual field CV of the virtual camera 300 based on the data transmitted from the position sensor 130 and/or the HMD sensor 114. In this case, when the user U wearing the HMD 110 moves, the control unit 121 can change the visual field CV of the virtual camera 300 based on the data representing the movement of the HMD 110, which is transmitted from the position sensor 130 and/or the HMD sensor 114. That is, the control unit 121 can change the visual field CV in accordance with the movement of the HMD 110. Similarly, when the line-of-sight direction of the user U changes, the control unit 121 can move the visual field CV of the virtual camera 300 based on the data representing the line-of-sight direction of the user U, which is transmitted from the eye gaze sensor 140. That is, the control unit 121 can change the visual field CV in accordance with the change in the line-of-sight direction of the user U.

In Step S3, the control unit 121 generates visual-field image data representing the visual-field image M to be displayed on the display unit 112 of the HMD 110. Specifically, the control unit 121 generates the visual-field image data based on the virtual space data defining the virtual space 200 and the visual field CV of the virtual camera 300.

In Step S4, the control unit 121 displays the visual-field image M on the display unit 112 of the HMD 110 based on the visual-field image data. As described above, the visual field CV of the virtual camera 300 is updated in accordance with the movement of the user U wearing the HMD 110, and thus the visual-field image M to be displayed on the display unit 112 of the HMD 110 is updated as well. Thus, the user U can be immersed in the virtual space 200.

The virtual camera 300 may include a left-eye virtual camera and a right-eye virtual camera. In this case, the control unit 121 generates left-eye visual-field image data representing a left-eye visual-field image based on the virtual space data and the visual field of the left-eye virtual camera. Further, the control unit 121 generates right-eye visual-field image data representing a right-eye visual-field image based on the virtual space data and the visual field of the right-eye virtual camera. After that, the control unit 121 displays the left-eye visual-field image and the right-eye visual-field image on the display unit 112 of the HMD 110 based on the left-eye visual-field image data and the right-eye visual-field image data. In this manner, the user U can visually recognize the visual-field image as a three-dimensional image from the left-eye visual-field image and the right-eye visual-field image. In this disclosure, for the sake of convenience in description, the number of the virtual cameras 300 is one. However, at least one embodiment of this disclosure is also applicable to a case where the number of the virtual cameras is at least two.

The hand object 400 (one example of the operation object), and the target object 500 (one example of the operation object) or the projection portion 210, which are arranged in the virtual space 200, are described with reference to FIGS. 9A and 9B. FIG. 9A is a diagram of a user U wearing the HMD 110 and the controllers 320L and 320R according to at least one embodiment. FIG. 9B is a diagram of the virtual space 200 including the virtual camera 300, the right hand object 400R, the left hand object 400L, and the target object 500 or the projection portion 210 according to at least one embodiment.

In FIG. 9B, the virtual space 200 includes the virtual camera 300, the left hand object 400L, the right hand object 400R, and the target object 500 or the projection portion 210. The control unit 121 generates the virtual space data for defining the virtual space 200 including those objects. As described above, the virtual camera 300 is synchronized with the movement of the HMD 110 worn by the user U. That is, the visual field of the virtual camera 300 is updated based on the movement of the HMD 110. Further, each of the left hand object 400L and the right hand object 400R has a collision area CA. In the collision area CA, determination on collision (contact) between the hand object 400 and the target object (for example, the target object 500 or the projection portion 210) is made. For example, when the collision area CA of the hand object 400 and a collision area of the target object 500 are brought into contact with each other, control unit 121 determines that the hand object 400 and the target object 500 are in contact with each other. Further, when the collision area CA of the hand object 400 and a collision area of the projection portion 210 are brought into contact with each other, control unit 121 determines that the hand object 400 and the projection portion 210 are in contact with each other. In FIG. 9B, the collision area CA may be defined as, for example, a sphere having a diameter R about a center position of the hand object 400. In the following description, the collision area CA is formed into a sphere shape having a diameter R about a center position of the hand object 400.

The collision area may also be set for the projection portion 210, and the contact between the target object 500 and the projection portion 210 may be determined based on the relationship between the collision area of the projection portion 210 and the collision area of the target object 500. With this, when a behavior of the target object 500 is operated by the hand object 400 (for example, the target object 500 is thrown), an action can be easily exerted on the projection portion 210 based on the target object 500 to make various kinds of determination.

The target object 500 can be moved by the left hand object 400L and the right hand object 400R. For example, a grabbing motion can be performed by operating the controller 320 under a state in which the hand object 400 and the target object 500 are in contact with each other so that the fingers of the hand object 400 are bent. When the hand object 400 is moved under this state, the target object 500 can be moved so as to follow the movement of the hand object 400. Further, when the grabbing motion of the hand object 400 is cancelled during the movement, the target object 500 can be moved in the virtual space 200 in consideration of the moving speed, the acceleration, the gravity, and the like of the hand object 400. With this, the user can use the controller 320 to manipulate the target object 500 at will through an intuitive operation such as grabbing or throwing the target object 500. Meanwhile, the projection portion 210 is a portion on which the omnidirectional video is projected, and hence the projection portion 210 is not moved or deformed even when the hand object 400 is brought into contact with the projection portion 210.

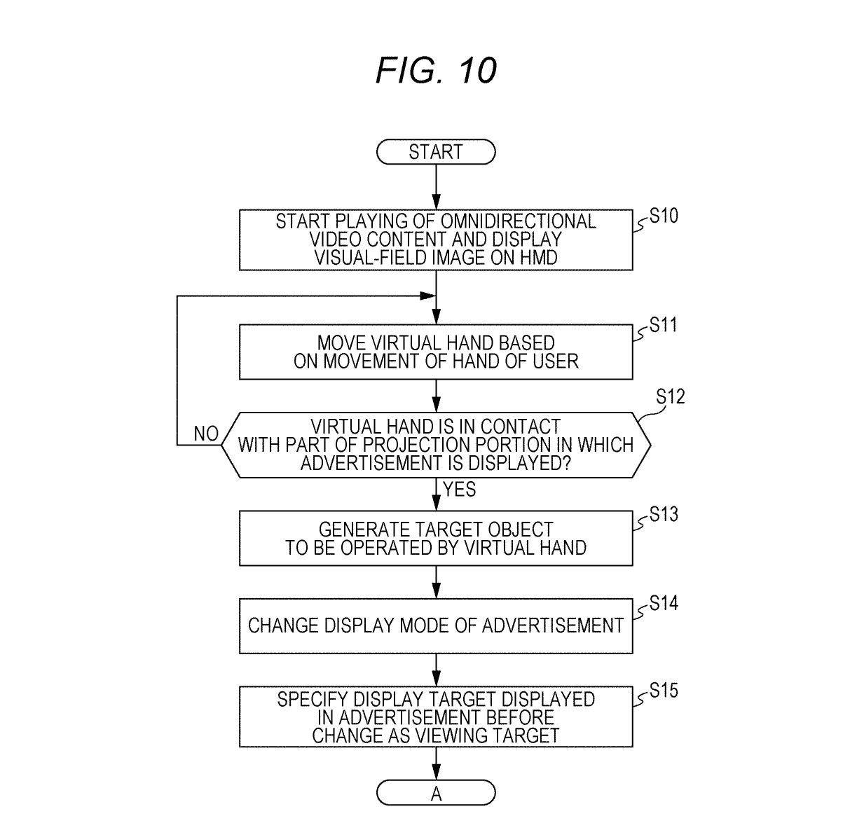

An information processing method according to at least one embodiment is described with reference to FIGS. 8A and 8B, and FIG. 10 to FIG. 21. In FIG. 10, in Step S10, the control unit 121 provides instructions for projecting the omnidirectional video forming the virtual content selected by the user onto the projection portion 210. After that, the control unit 121 executes processing similar to Step S1 to Step S4, to thereby display the visual-field image Mon the HMD 110. In at least one embodiment, as in FIG. 8B, the hand objects 400L and 400R are generated in front of the virtual camera 300. Further, omnidirectional video including a wall W, various types of furniture F, characters C1, and a display portion DP on which an advertisement AD1 is displayed is projected on the projection portion 210. Therefore, as in FIG. 8A, also in the visual-field image M, there are displayed the wall W, the various types of furniture F, the characters C1, and the display portion DP on which the advertisement AD1 is displayed, which are positioned within the visual field of the virtual camera 300. In FIG. 8B, only the advertisement AD1 and some of the characters C1 in the omnidirectional video are representatively illustrated.

In at least one embodiment, the projection portion 210 is sectioned into a plurality of parts. As in FIG. 8B, latitude lines and longitude lines that are set at predetermined intervals are defined on the celestial sphere-shaped projection portion 210, to thereby section the projection portion 210 in a grid manner. For example, the virtual camera 300 is arranged at the center 21 (see FIG. 6) of the virtual space 200, and the latitude lines are set so that a predetermined angular spacing is obtained in a direction of a perpendicular direction of the virtual camera 300. Further, the longitude lines are set so that a predetermined angular spacing is obtained in a direction of a horizontal direction of the virtual camera 300. In FIG. 8B, the character C1 of a cat is arranged in a grid section 211, and the advertisement AD1 of water is arranged in a grid section 212. The grid sections 211 and 212 in which at least a part of the character C1 or the advertisement AD1 is arranged as described above are sometimes referred to as “first part” in the projection portion 210. Further, the grid sections other than the grid section 211 in which the character C1 is arranged and the grid sections other than the grid section 212 in which the advertisement AD1 is arranged are sometimes referred to as “second part” in the projection portion 210.

In Step S11, the control unit 121 provides instructions for moving the hand object 400 as described above based on the movement of the hand of the user U, which is detected by the controller 320.

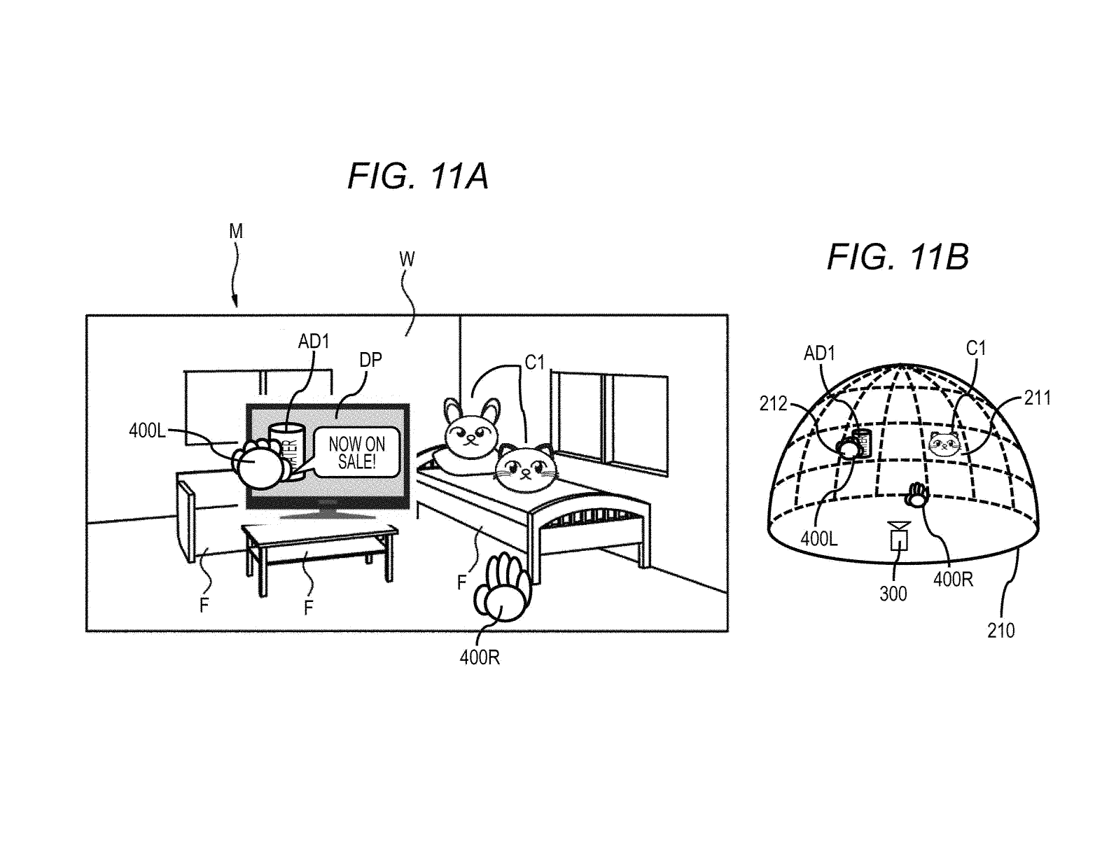

In Step S12, the control unit 121 determines whether or not the hand object 400 is in contact with the grid section 212 of the projection portion 210 in which the advertisement AD1 is displayed. In at least one embodiment, as in FIGS. 11A and 11B, when the hand object 400 is brought into contact with the grid section 212, and the hand object 400 performs a grabbing motion by bending all of the fingers of the hand object 400, the advertisement AD1 can be selected. As described above, the contact between the hand object 400 and the grid section 212 is determined based on the position at which the contact between the projection portion 210 and the collision area CA set for the hand object 400 is determined.

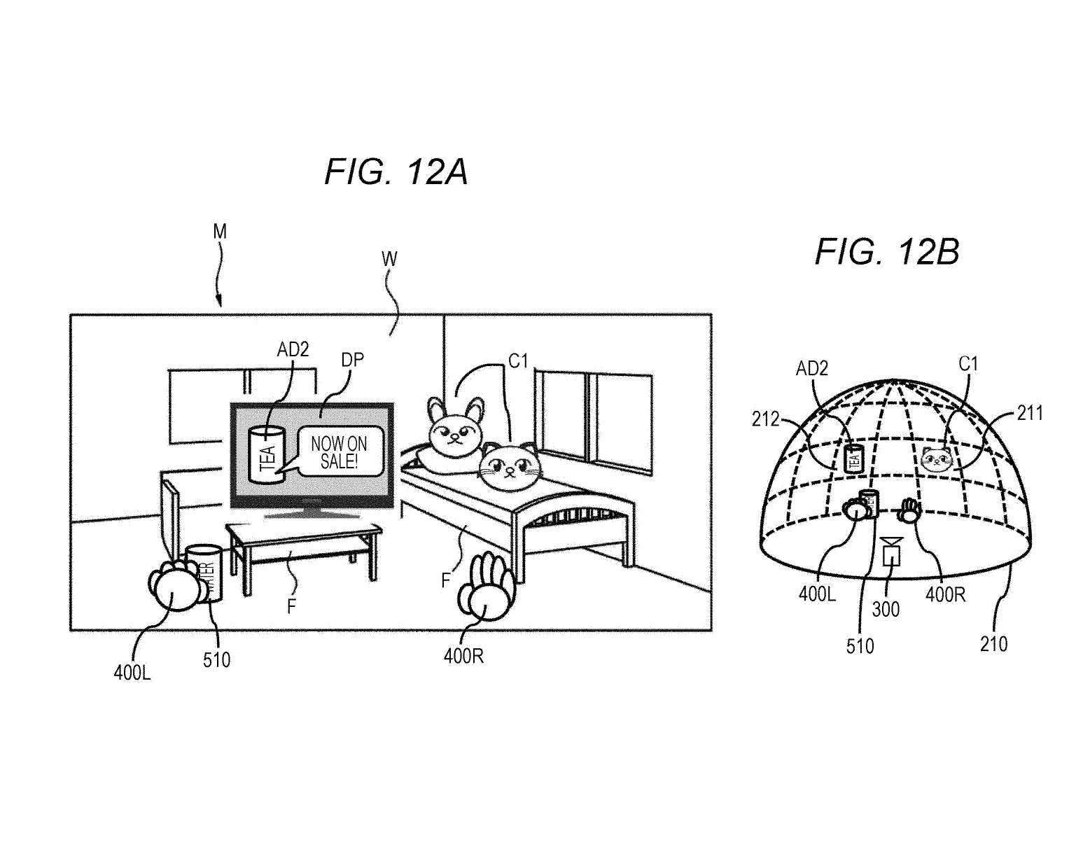

When the hand object 400 is moved under a state in which the advertisement AD1 is selected as described above, in Step S13, the control unit 121 generates a target object 510, and provides instructions for operating the target object 510 based on the operation of the hand object 400. In at least one embodiment, as in FIGS. 12A and 12B, the target object 510 is generated as a 3D object corresponding to the advertisement AD1 displayed on the display portion DP. With this, when the user directs his or her line of sight to the display portion DP while viewing the omnidirectional moving image, and the user U is interested in the displayed advertisement AD1, the user U can pick up the object of the advertisement AD1 as a 3D object to freely look at the object from any angle by operating the hand object 400. Thus, the advertising effectiveness is expected to be enhanced.

Further, in at least one embodiment, the control unit 121 can store in advance in the storage unit 123, together with the omnidirectional moving image, the 3D object corresponding to the advertisement AD1 to be played in the omnidirectional moving image as the virtual space data. With this, based on a limited amount of data such as the omnidirectional moving image and the 3D model corresponding to the advertisement AD1, a virtual experience that is based on the interaction with the virtual content may be provided to the user.

In Step S14, the control unit 121 changes a display mode of the advertisement displayed on the display portion DP in the projection portion 210 from the advertisement AD1 to an advertisement AD2. As in of FIG. 12A, after the user picks up the target object 510 corresponding to the advertisement AD1, the advertisement AD2 is subsequently displayed so that content such as various advertisements may be provided to the user.

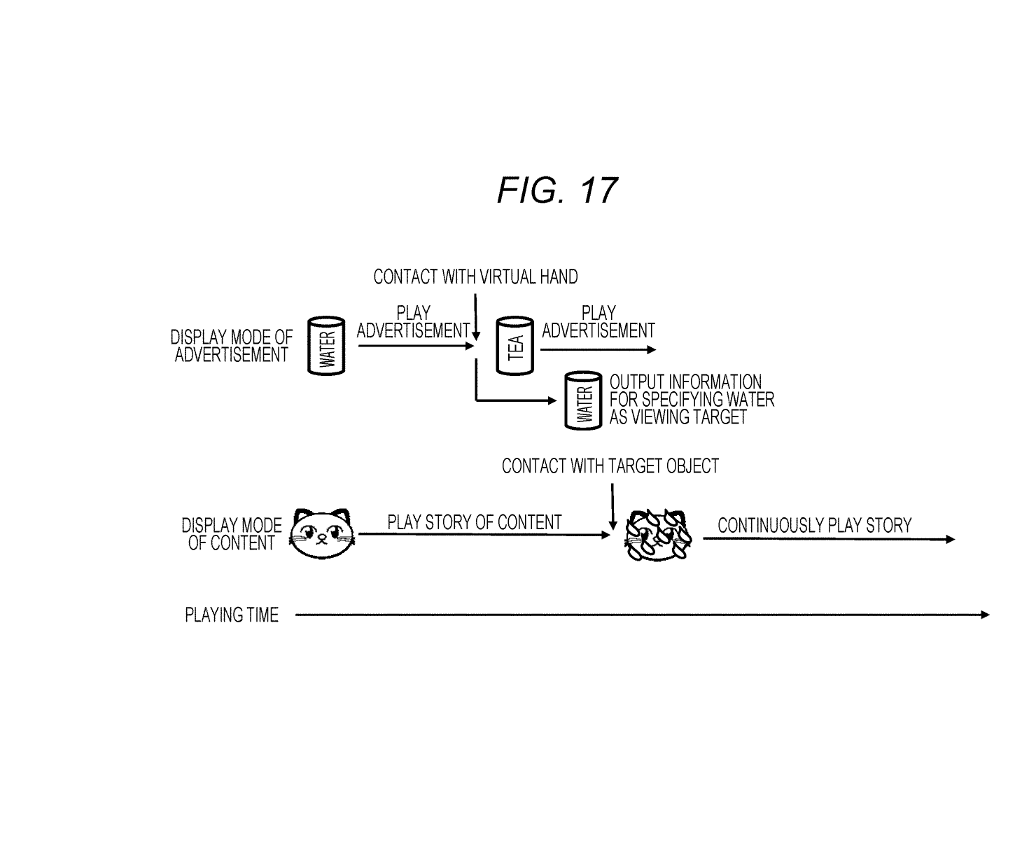

In Step S15, as in FIG. 17, the control unit 121 is used to specify the advertisement AD1, which is a display target displayed on the advertisement before the change, as a viewing target. The advertisement AD1 that is picked up by the user as the target object 510 is a target in which the user may be highly likely to show interest. Therefore, the control unit 121 outputs information for specifying the advertisement AD1 to transmit the information to the content management server 4. The information is stored in the viewing data management unit 43. In this manner, the advertising effectiveness of the advertisement AD1 can be measured.

In at least one embodiment, the information for specifying the advertisement AD1 includes information on time at which the hand object 400 and the grid section 212 in which the advertisement AD1 is displayed are brought into contact with each other. With this, the data communication amount for transmitting or receiving the viewing data can be reduced.

Further, specifying the advertisement AD1 as the viewing target is not limited to when the hand object 400 touches the display portion DP in the projection portion 210. For example, the advertisement AD1 may be specified as the viewing target when the behavior of the operation object 500 is operated as appropriate (for example, the operation object 500 is thrown) based on the hand object 400 as described later, and thus the operation object 500 is brought into contact with the display portion DP.

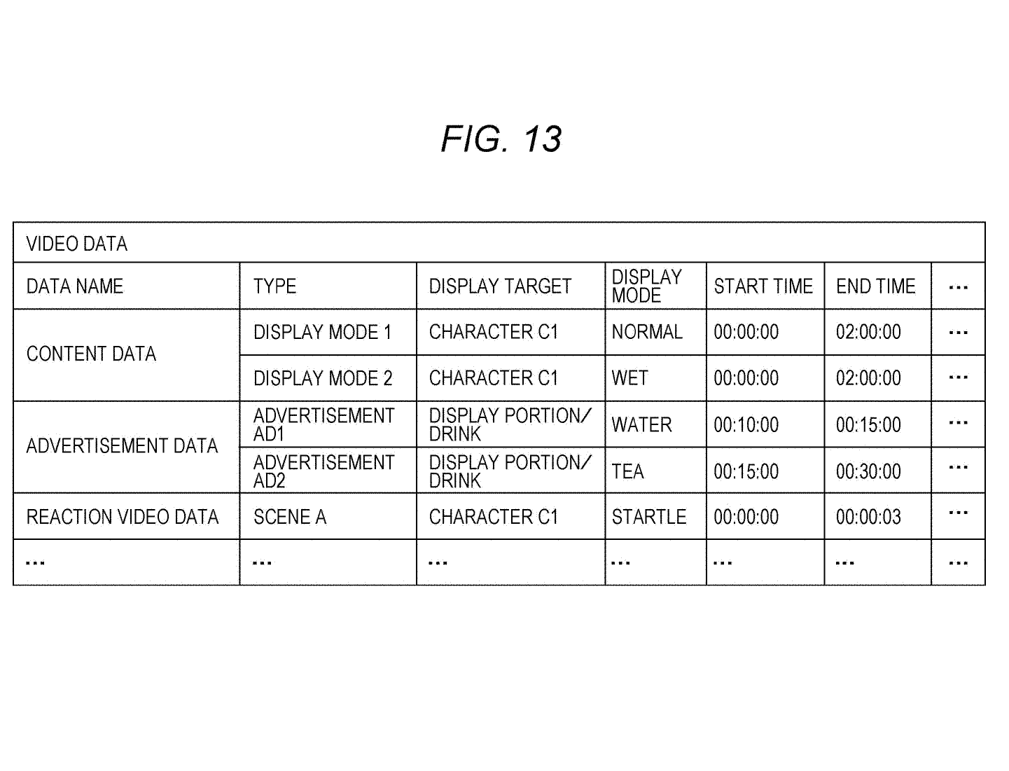

In the storage unit 123 and the content management unit 42, video data for defining the omnidirectional video as in FIG. 13 is stored. The video data includes content data for defining details corresponding to the story of the omnidirectional video content, and advertisement data for defining an advertisement corresponding to the content to be inserted into a part of the omnidirectional video (corresponding to the display portion DP). The omnidirectional video may be generated by combining video based on the advertisement data with a part of the video based on the content data. In at least one embodiment, the advertisement data includes the advertisement AD1 and the advertisement AD2, and is defined to be displayed as a display mode of a drink on the display portion DP being the display target. As in FIG. 13 and FIG. 17, the advertisement AD1 is displayed for a period from 10 minutes to 15 minutes from the start of playing the content, and the advertisement AD2 is displayed in a period from 15 minutes to 30 minutes. When the advertisement AD1 is selected by the hand object 400 in the period of from 10 minutes to 15 minutes, the advertisement AD2 is displayed thereafter until the time of 30 minutes. Therefore, the advertisement selected by the user may be specified based on the information on time at which the hand object 400 and the grid section 212 in which the advertisement AD1 is displayed are brought into contact with each other. Further, as described later, while the omnidirectional video is played based on the content data, reaction video may be temporarily inserted due to the action by the user based on the operation object. With this, omnidirectional video capable of interacting with the user may be provided.

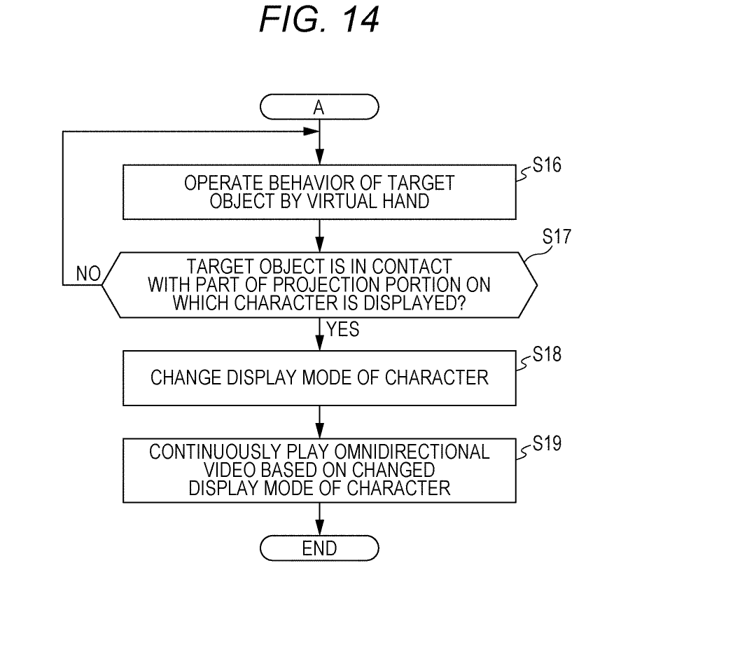

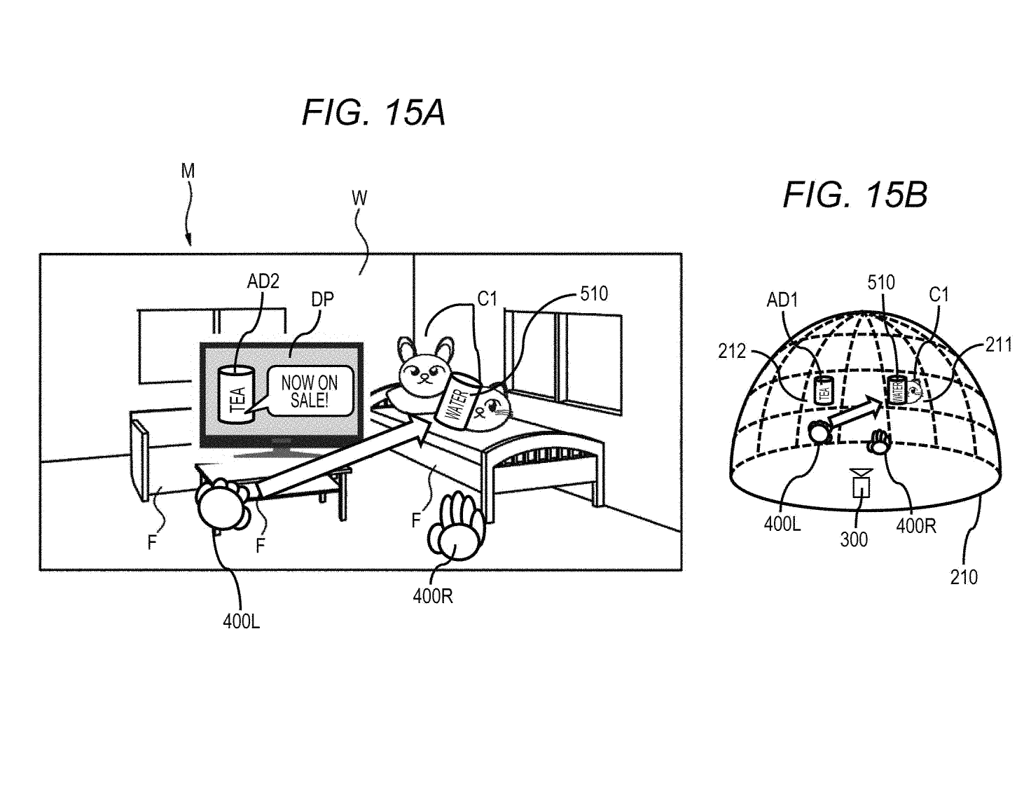

Further, as in FIG. 14, in Step S16, the behavior of the target object 510 is operated by the hand object 400. The flowchart in FIG. 14 begins after step S15 of the flowchart in FIG. 10, as indicated by the symbol “A”. In this embodiment, as in FIG. 15A, when the hand object 400 is moved under a state in which the hand object 400 is grabbing the target object 510, the target object 510 can be moved so as to follow the movement of the hand object 400. Further, when the grabbing motion of the hand object 400 is cancelled during the movement, the target object 510 can be moved in the virtual space 200 in consideration of the moving speed, the acceleration, the gravity, and the like of the hand object 400. When the grabbing motion of the hand object 400 is cancelled during the movement of the target object 510 in the direction indicated by the arrow in FIG. 15A, the behavior of the target object 510 is operated as if the target object 510 is thrown in the direction indicated by the arrow.

In Step S17, the control unit 121 determines whether or not the target object 510 is in contact with the first part in the projection portion 210. In FIG. 15B, control unit 121 determines that the target object is in contact with the grid section 211 on which the character C1 of the cat is projected.

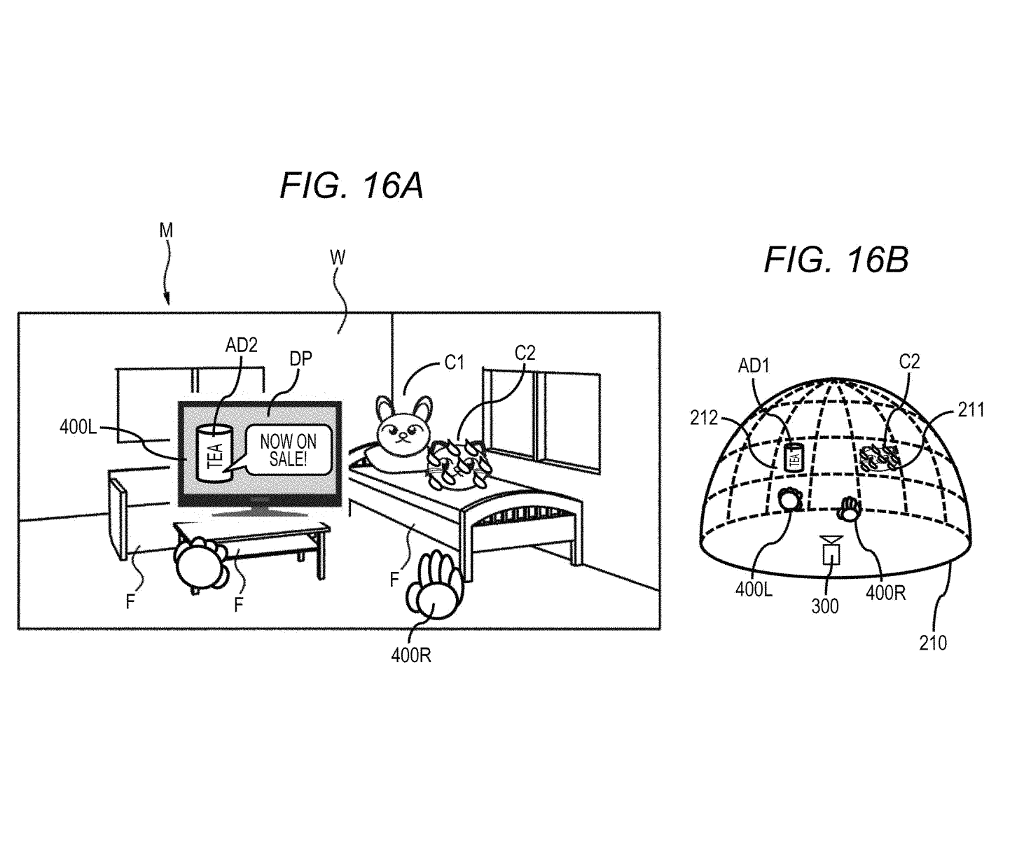

In Step S18, the control unit 121 changes a display mode of the character C1 of the cat projected on the first part 211 of the projection portion 210 with which the target object 510 is in contact from a first mode (normal state) C1 before contact to a second mode (wet state) C2 as illustrated in FIGS. 16A and 16B. In at least one embodiment, the display mode of the character C1 before change and the display mode of the character C2 after the change are defined by the video data of FIG. 13. For example, there are at least two prepared types of content data forming the virtual content and having different display modes for the character C1. The at least two types of content data are data for displaying the same content with different display modes. Although the display mode of the character C1 differs, the entire story and the start and end times as the omnidirectional video are the same. Therefore, although the display mode of the character C1 differs, the change of the display mode along with elapse of the playing time of the omnidirectional video (for example, motion of the character based on the progress of the story) is the same.

In Step S19, the control unit 121 provides instructions for continuously playing the omnidirectional video based on the display mode of the character after the change (character C2 of the cat in the wet state described above). As described above, the story is the same as the entire virtual content regardless of before or after the display mode is changed. Therefore, the user is provided with a virtual experience that is based on the interaction with the virtual content while providing the omnidirectional video that progresses based on predetermined content.

Regarding the at least two types of content data of FIG. 13, the at least two types may be stored as the entire omnidirectional video, or may be set for each grid section. For example, the content data corresponding to the display mode of the character C2 of the cat after the change may be defined only for the grid section 211 in which the character is arranged, and the content data corresponding to the display mode before the change may be stored as the entire omnidirectional video. With this, when the display mode of the character C1 is changed, processing of combining the two types of content data may be performed only in the part of the grid section 211. In this manner, the omnidirectional video may be easily provided based on the character C2 displayed in the second mode. Further, the above-mentioned content data processing may be similarly applied to the advertisement data described above.

FIG. 17 is a diagram of the information processing method according to at least one embodiment is summarized based on the playing time of the omnidirectional video. First, the control unit 121 generates the omnidirectional video including the character C1 in the display mode 1 and the advertisement AD1 based on the video data of FIG. 13, which is stored in the storage unit 123, and provides instructions for playing the omnidirectional video. When the user operates the hand object 400 to bring the hand object 400 in contact with the grid section 212, the control unit 121 provides instructions for changing the display mode of the advertisement from the advertisement AD1 being the first mode to the advertisement AD2 being the second mode based on the video data stored in the storage unit 123. Then, the control unit 121 outputs information for specifying the advertisement AD1 as the user's viewing target to transmit the information to the content management server 4.

Further, the target object 510 is generated when the user performs a grabbing motion under a state in which the hand object 400 is in contact with the grid section 212. The behavior of the target object 510 is operated based on the operation of the hand object 400. When control unit 121 determines that the target object 510 is in contact with the grid section 211, the control unit 121 changes the display mode of the character C1 from the character C1 being the first mode to the character C2 being the second mode based on the video data stored in the storage unit 123. Then, the omnidirectional video that is based on a predetermined story is continuously played based on the character C2 displayed in the second mode. The omnidirectional video that is based on the predetermined story may be played based on the character C2 displayed in the second mode only for a predetermined period, and then the playing of the omnidirectional video that is based on the predetermined story may be restarted based on the character C1 displayed in the first mode.

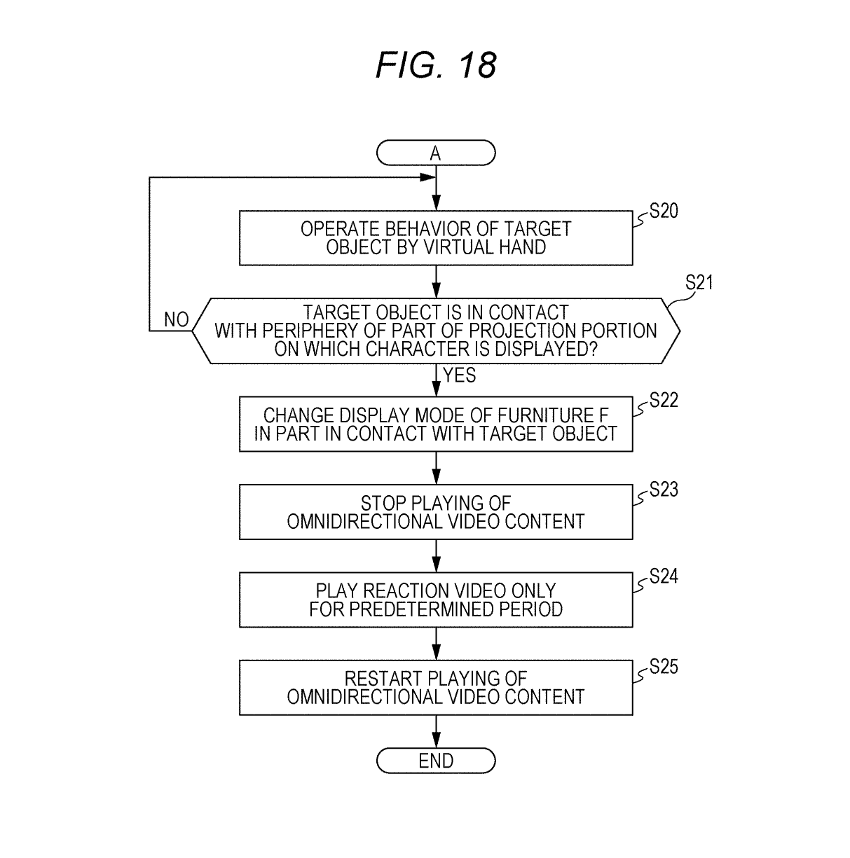

With reference to FIG. 18 to FIG. 21, description is given of at least one embodiment of this disclosure. The omnidirectional video is generated and played based on the video data of FIG. 13.

FIG. 18 is a flow chart of the information processing method to be executed in this system according to at least one embodiment. The flowchart of FIG. 18 begins after step S15 of the flowchart in FIG. 10, as indicated by the symbol “A”.

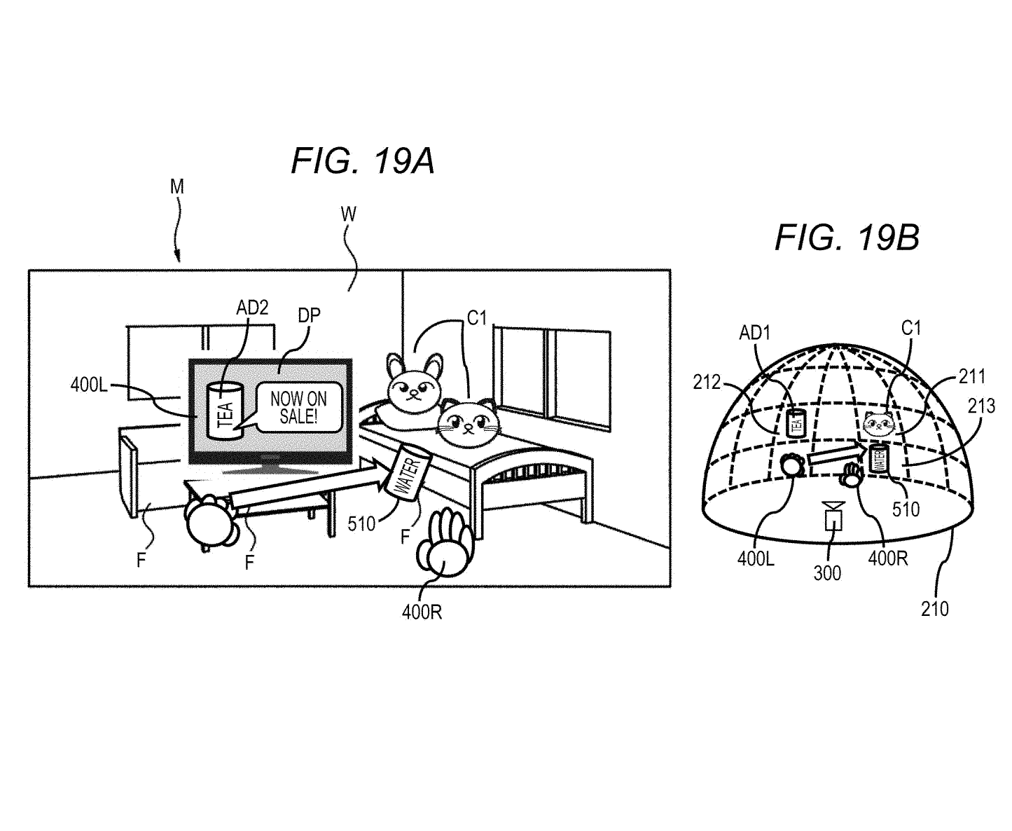

In Step S20, as in FIGS. 19A and 19B, the behavior of the target object 510 is operated by the hand object 400. Also in at least one embodiment, as in FIG. 19A, when the hand object 400 is moved under a state in which the hand object 400 is grabbing the target object 510, the target object 510 can be moved so as to follow the movement of the hand object 400. Further, when the grabbing motion of the hand object 400 is cancelled during the movement, the target object 510 can be moved in the virtual space 200 in consideration of the moving speed, the acceleration, the gravity, and the like of the hand object 400. When the grabbing motion of the hand object 400 is cancelled during the movement of the target object 510 in the direction indicated by the arrow in FIG. 19A, the behavior of the target object 510 is operated as if the target object 510 is thrown in the direction indicated by the arrow.

In Step S21, the control unit 121 determines whether or not the target object 510 is in contact with a periphery of the first part 211 in the projection portion 210. In FIG. 19B, control unit 121 determines whether the target object is in contact with a grid section 213 adjacent to the grid section 211 on which the character C1 of the cat is projected. Parts of the projection portion 210 other than the part in which at least a part of the character C1 being a predetermined display target is arranged are sometimes referred to as “second part” in the projection portion 210. In at least one embodiment, as an example of the second part, the grid section 213 adjacent to the grid section 211 on which the character C1 being the predetermined display target is projected is shown.

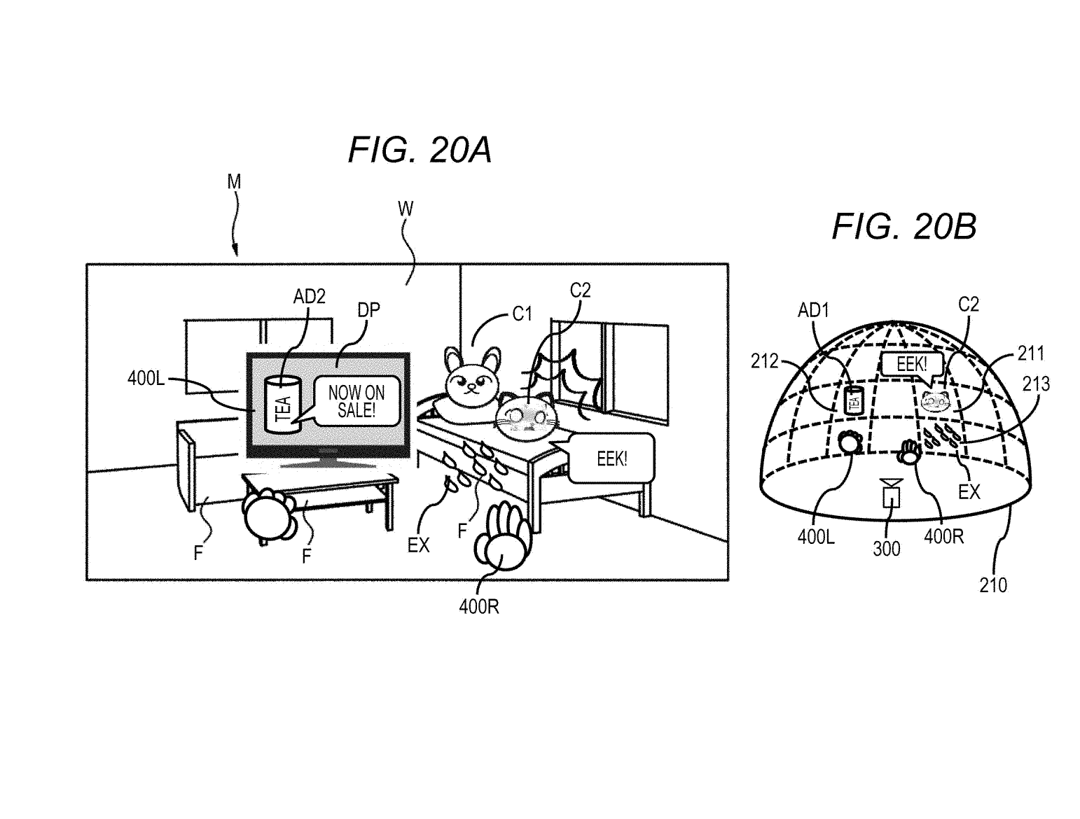

In Step S22, the control unit 121 provides instructions for changing the display mode of the furniture F, which is projected on the projection portion 213 with which the target object 510 is in contact, from the first mode (normal state) before the contact to the second mode (wet state) as in FIGS. 20A and 20B. Also in at least one embodiment, the control unit 121 may execute the processing of changing the display mode of the furniture F based on the video data stored in the storage unit 123.

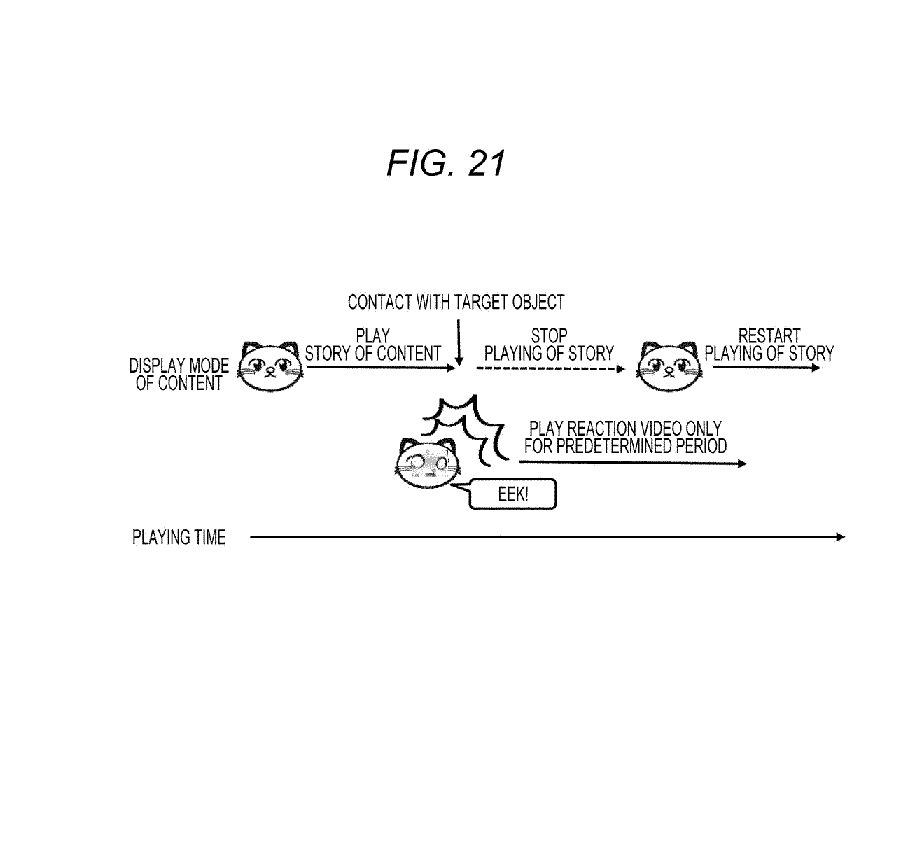

In at least one embodiment, as in FIG. 21, the omnidirectional video being played based on the content data may be temporarily stopped (Step S23), and reaction video defined by the video data of FIG. 13 may be played only for a predetermined period (Step S24). The reaction video has content (second mode) different from the content data (first mode) for defining the story of the virtual content, and the details of the virtual content are temporarily changed based on the action by the user (operation object) to the projection portion 210.

As defined in FIG. 13, the reaction video data designates a type for defining the timing (scene) to be played, a display target, a display mode, and a playing time. In at least one embodiment, as a scene in which the reaction video is played, there be defined a case where the operation object 510 is in contact with the grid section 213 adjacent to the grid section 211 on which the character C1 is projected. The above-mentioned character C1 is designated as the display target, and video data representing a state where the character C1 is startled is designated as the display mode. Further, three seconds are designated as the playing time. One of ordinary skill in the art would understand that different playing time durations are within the scope of this disclosure. The reaction video is played only for three seconds after the operation object 510 is in contact with the grid section 213, and then, as in Step S25, the playing of the omnidirectional video content is restarted based on the content data.

The above description of some of the embodiments is not to be read as a restrictive interpretation of the technical scope of this disclosure. The described embodiments are merely given as an example, and a person skilled in the art would understand that various modifications can be made to the described embodiments within the scope of this disclosure set forth in the appended claims. Thus, the technical scope of this disclosure is to be defined based on the scope of this disclosure set forth in the appended claims and equivalents thereof.

In at least one embodiment, the movement of the hand object is controlled based on the movement of the external controller 320 representing the movement of the hand of the user U, but the movement of the hand object in the virtual space may be controlled based on the movement amount of the hand of the user U himself/herself. For example, instead of using the external controller, a glove-type device or a ring-type device to be worn on the hand or fingers of the user may be used. With this, the position sensor 130 can detect the position and the movement amount of the hand of the user U, and can detect the movement and the state of the hand and fingers of the user U. Further, the position sensor 130 maybe a camera configured to take an image of the hand (including the fingers) of the user U. In this case, by taking an image of the hand of the user with use of a camera, the position and the movement amount of the hand of the user U can be detected, and the movement and the state of the hand and fingers of the user U can be detected based on data of the image in which the hand of the user is displayed, without wearing any kind of device directly on the hand or fingers of the user.

Further, in at least one embodiment, there is set a collision effect for defining the influence to be exerted on the target object by the hand object based on the position and/or the movement of the hand, which is a part of the body of the user U other than the head, but the embodiments are not limited thereto. For example, there maybe set a collision effect for defining, based on apart of the body of the user U other than the head (for example, position and/or movement of the foot), the influence to be exerted on the target object by a virtual body (virtual foot, foot object: one example of the operation object) that is synchronized with the part of the body of the user U (for example, movement of the virtual foot). As described above, in at least one embodiment, there may be set a collision effect for specifying a relative relationship (distance and relative speed) between the HMD 110 and a part of the body of the user U, and defining the influence to be exerted on the target object by the virtual body (operation object) that is synchronized with the part of the body of the user U based on the specified relative relationship.

Further, in at least one embodiment, the user is immersed in a virtual space (VR space) with use of the HMD 110, but a transmissive HMD may be employed as the HMD 110. In this case, an image obtained by combining an image of the target object 500 with the real space to be visually recognized by the user U via the transmissive HMD 110 maybe output, to thereby provide a virtual experience as an AR space or an MR space. Then, the target object 500 may be selected or deformed based on the movement of a part of the body of the user instead of the first operation object or the second operation object. In this case, the real space and coordinate information of the part of the body of the user are specified, and coordinate information of the target object 500 is defined based on the relationship with the coordinate information in the real space. In this manner, an action can be exerted on the target object 500 based on the movement of the body of the user

U.

What is claimed is:

1. An information processing method comprising:
specifying virtual space data for defining a virtual space including a virtual camera, an operation object, and omnidirectional video, and a projection portion;
projecting the omnidirectional video on the projection portion in a first mode;
detecting a movement of a head mounted display (HMD) and a part of a body of a user other than a head of the user;
moving the virtual camera in response to the movement of the HMD;
defining a visual field of the virtual camera in response to a movement of the virtual camera;
displaying a visual-field image on the HMD based on the visual-field;
moving the operation object in response to the movement of the part of the body;
detecting contact between the operation object and the projection portion; and
projecting the omnidirectional video on the projection portion in a second mode different from the first mode in response to the contact.

2. The information processing method according to claim 1,
wherein the projection portion is sectioned into a plurality of parts including a first part and a second part different from the first part, and at least a part of a display target is displayed on the first part, and
projecting the omnidirectional video in the second mode comprises changing a display mode of the display target to change the omnidirectional video from the first mode to the second mode in response to a determination that the operation object is in contact with the first part.

3. The information processing method according to claim 1,
wherein the projection portion is sectioned into a plurality of parts including a first part and a second part different from the first part, and a display of a display target is separated from the second part, and
projecting the omnidirectional video in the second mode comprises changing a display mode of the display target to change the omnidirectional video from the first mode to the second mode in response to a determination that the operation object is in contact with the second part.

4. The information processing method according to claim 1, wherein specifying the virtual space data comprises specifying the virtual space data including the operation object as a virtual body that is movable in synchronization with the detected movement of the part of the body.

5. The information processing method according to claim 2, wherein specifying the virtual space data comprises specifying the virtual space data including the operation object as a virtual body that is movable in synchronization with the detected movement of the part of the body.

6. The information processing method according to claim 3, wherein specifying the virtual space data comprises specifying the virtual space data including the operation object as a virtual body that is movable in synchronization with the detected movement of the part of the body.

7. The information processing method according to claim 1, wherein specifying the virtual space data comprises specifying the virtual space data including the operation object as a target object capable of exhibiting a behavior operated by a virtual body that is movable in synchronization with the movement of the part of the body.

8. The information processing method according to claim 2, wherein specifying the virtual space data comprises specifying the virtual space data including the operation object as a target object capable of exhibiting a behavior operated by a virtual body that is movable in synchronization with the movement of the part of the body.

9. The information processing method according to claim 3, wherein specifying the virtual space data comprises specifying the virtual space data including the operation object as a target object capable of exhibiting a behavior operated by a virtual body that is movable in synchronization with the movement of the part of the body.

10. The information processing method according to claim 4,
wherein the projection portion is sectioned into a plurality of parts including a first part and a second part different from the first part, and at least a part of a display target is displayed on the first part,
wherein the display target is configured to change a display mode based on the first mode along with elapse of a playing time of the omnidirectional video, and
changing the display mode of the display target to change the omnidirectional video from the first mode to the second mode in response to a determination that the operation object is in contact with the first part; and
specifying a viewing target associated with the display target based on a time at which the operation object is brought into contact with the first part.

11. The information processing method according to claim 4,
wherein the projection portion is sectioned into a plurality of parts including a first part and a second part different from the first part, and a display of a display target is separated from the second part,
wherein the display target is configured to change a display mode based on the first mode along with elapse of a playing time of the omnidirectional video, and
changing the display mode of the display target to change the omnidirectional video from the first mode to the second mode in response to a determination that the operation object is in contact with the second part; and
specifying a viewing target associated with the display target based on a time at which the operation object is brought into contact with the first part.

12. The information processing method according to claim 7,
wherein the projection portion is sectioned into a plurality of parts including a first part and a second part different from the first part, and at least a part of a display target is displayed on the first part,
wherein the display target is configured to change a display mode based on the first mode along with elapse of a playing time of the omnidirectional video, and
changing the display mode of the display target to change the omnidirectional video from the first mode to the second mode in response to a determination that the operation object is in contact with the first part; and
specifying a viewing target associated with the display target based on a time at which the operation object is brought into contact with the first part.

13. The information processing method according to claim 7,
wherein the projection portion is sectioned into a plurality of parts including a first part and a second part different from the first part, and a display of a display target is separated from the second part,
wherein the display target is configured to change a display mode based on the first mode along with elapse of a playing time of the omnidirectional video, and
changing the display mode of the display target to change the omnidirectional video from the first mode to the second mode in response to a determination that the operation object is in contact with the second part; and
specifying a viewing target associated with the display target based on a time at which the operation object is brought into contact with the first part.

14. The information processing method according to claim 4,
wherein the projection portion is sectioned into a plurality of parts including a first part and a second part different from the first part, and at least a part of a display target is displayed on the first part, wherein the display target is configured to change a display mode along with elapse of a playing time of the omnidirectional video, based on one of the first mode and the second mode for displaying the same content in different display modes, and
projecting the omnidirectional video in the second mode comprises, in response to a determination that the operation object is in contact with the first part, changing the display mode of the display target to change the omnidirectional video from the first mode to the second mode, and continuously projecting the display target based on the second mode along with the elapse of the playing time.

15. The information processing method according to claim 4,
wherein the projection portion is sectioned into a plurality of parts including a first part and a second part different from the first part, and a display of a display target is separated from the second part,
wherein the display target is configured to change a display mode along with elapse of a playing time of the omnidirectional video, based on one of the first mode and the second mode for displaying the same content in different display modes, and
projecting the omnidirectional video in the second mode comprises, in response to a determination that the operation object is in contact with the second part, changing the display mode of the display target to change the omnidirectional video from the first mode to the second mode, and continuously projecting the display mode of the display target based on the second mode along with the elapse of the playing time.

16. The information processing method according to claim 7,
wherein the projection portion is sectioned into a plurality of parts including a first part and a second part different from the first part, and at least a part of a display target is displayed on the first part,
wherein the display target is configured to change a display mode along with elapse of a playing time of the omnidirectional video, based on one of the first mode and the second mode for displaying the same content in different display modes, and
projecting the omnidirectional video in the second mode comprises, in response to a determination that the operation object is in contact with the first part, changing the display mode of the display target to change the omnidirectional video from the first mode to the second mode, and continuously projecting the display target based on the second mode along with the elapse of the playing time.

17. The information processing method according to claim 7,
wherein the projection portion is sectioned into a plurality of parts including a first part and a second part different from the first part, and a display of a display target is separated from the second part,
wherein the display target is configured to change a display mode along with elapse of a playing time of the omnidirectional video, based on one of the first mode and the second mode for displaying the same content in different display modes, and
projecting the omnidirectional video in the second mode comprises, in response to a determination that the operation object is in contact with the second part, changing the display mode of the display target to change the omnidirectional video from the first mode to the second mode, and continuously projecting the display target based on the second mode along with the elapse of the playing time.

18. The information processing method according to claim 4,
wherein the projection portion is sectioned into a plurality of parts including a first part and a second part different from the first part, at least a part of a display target is displayed on the first part, and the display of the display target is separated from the second part,
wherein the display target is configured to change a display mode along with elapse of a playing time of the omnidirectional video, based on one of the first mode and the second mode for forming different contents, and
changing the display mode of the display target to change the omnidirectional video from the first mode to the second mode in response to a determination that the operation object is in contact with the first part or in response to a determination that the operation object is in contact with the second part;
stopping projecting the display target based onathe first mode along with the elapse of the playing time;
projecting the display target based on the second mode for a predetermined period along with the elapse of the playing time; and
restarting projecting the display target based on the first mode along with the elapse of the playing time.

19. The information processing method according to claim 4,
wherein the projection portion is sectioned into a plurality of parts including a first part and a second part different from the first part, at least a part of a display target is displayed on the first part, and the display of the display target is separated from the second part,
wherein the display target is configured to change a display mode along with elapse of a playing time of the omnidirectional video, based on one of the first mode and the second mode for forming different contents, and
projecting the omnidirectional video in the second mode comprises:
changing the display mode of the display target to change the omnidirectional video from the first mode to the second mode in response to a determination that the operation object is in contact with the first part or in response to a determination that the operation object is in contact with the second part;
stopping projecting the display target based on the first mode along with the elapse of the playing time;
projecting the display target based on the second mode for a predetermined period along with the elapse of the playing time; and
restarting projecting the display target based on the first mode along with the elapse of the playing time.

20. A system for executing an information processing method, wherein the system comprises:
a processor; and
a non-transitory computer readable medium connected to the processor, wherein the processor is configured to execute instructions stored on the non-transitory computer readable medium for:
specifying virtual space data for defining a virtual space including a virtual camera, an operation object, and omnidirectional video, and a projection portion;
providing instructions for projecting the omnidirectional video on the projection portion in a first mode;
providing instructions for detecting a movement of a head mounted display(HMD) and a part of a body of a user other than a head of the user;
providing instructions for moving the virtual camera in response to the movement of the HMD;
providing instructions for defining a visual field of the virtual camera in response to a movement of the virtual camera;
providing instructions for displaying a visual-field image on the HMD based on the visual-field;
providing instructions for moving the operation object in response to the movement of the part of the body;
providing instructions for detecting contact between the operation object and the projection portion; and
providing instructions for projecting the omnidirectional video on the projection portion in a second mode different from the first mode in response to the contact.
